(19) United States
(12) Patent Application Publication
(10) Pub. No.: US 2016/0196574 A1
(43) Pub. Date: Jul. 7, 2016

(54) Discovery and Mobile device Characteristics based Advertising and Billing Framework

(71) Applicant: QUALCOMM Incorporated, San Diego, CA (US)

(72) Inventors: Shriram Ganesh, San Diego, CA (US); Hemang Jayant Shah, Bangalore (IN); Sandeep Sharma, San Diego, CA (US)

(21) Appl. No.: 14/588,648

(22) Filed: Jan. 2, 2015

(51) Int. Cl. G06Q 30/02

(52) U.S. Cl. CPC G06Q 30/0246; G06Q 30/0273

(57) ABSTRACT

Methods and mobile devices enable adjusting an advertising rate charged to an advertiser for ad content presented by an advertising device. A presence of a mobile device in proximity to the advertising device may be detected. Information such as mobile device characteristics may be obtained from the mobile device indicative of a state of attentiveness of a user of the mobile device to the advertising device. The advertising rate charged to the advertiser for the ad content presented by the advertising device may be adjusted based on the obtained information indicative of the state of attentiveness of the user of the mobile device.

### BACKGROUND

Advertising rates can be a significant cost for advertisers. Presently, publicly placed television screens, billboards and related electronic display mobile devices may be configuration as advertising devices to present advertising along with other content, or may be configured as dedicated advertising devices. Advertising devices may be placed in public places, such as airports, train or bus stations, shopping malls, on buildings in city shopping districts, along freeways, etc. In exchange for presenting their ads on such mobile devices, advertisers typically pay a fixed cost per instance of presentation of an advertisement, per time period during which advertisements are run, and so on. Further, advertising costs are typically assessed using an advertising rate that is based on a predefined model of the likely viewers of the ad, such as likely views by the same and different potential customers, percentage of viewers that are the advertiser's target audience, type of advertisement (e.g., static image, video, audio, video and audio, etc.), and other factors related to how likely the advertisement is going to be effective.

With many advertising devices it is not possible to know in advance how effective an advertisement presentation will be in reaching the advertiser's target audience. While surveys may be used to estimate the number of people passing by a display site (e.g., a billboard or video display) throughout the day and week, it is typically not possible to know in advance the make-up of the audience, the percentage of the audience that can see/hear the ad, and whether there are distractions or other reasons that render the ad ineffective. Thus, in conventional advertising presentation and billing systems the attentiveness of individuals who actually view an ad are not considered in the advertising rates used to charge advertisers. Advertisers typically want to pay only for ad views that are effective, and therefore accept ad rates based on a fraction of potential views that attempts to model the likely effective views. Thus, the per viewing advertising rate that is charged for ads presented on public advertising devices is typically much less than would be the case if the advertising rate could be based on the number of times the ad was effectively presented to a target audience viewer.

### SUMMARY

The various embodiments include methods and devices implementing the methods for device for adjusting an advertising rate charged to an advertiser for advertising content presented by the advertising device based on information indicative of the number of individuals who may perceive and be attentive to a rendered advertisement. In an embodiment a method may include detecting, by an advertising device, a presence of a mobile device in proximity to the advertising device, obtaining, by the advertising device, information from the mobile device indicative of a state of attentiveness of a user of the mobile device to the advertising device, and adjusting the advertising rate charged to the advertiser for the advertising content presented by the advertising device based on the obtained information indicative of the state of attentiveness of the user of the mobile device.

In various embodiments the information indicative of the state of attentiveness of the user of the mobile device may include information associated with one or more of: a distance of the mobile device from the advertising device; a position of the mobile device relative to a field of view of a display of the advertising device; a position of the mobile device relative to a field of audibility of an audio output of the advertising device; an ambient noise level of an area around the advertising device; a placement of the mobile device in a pocket of the user; a state of interaction of the user with the mobile device; a movement of the mobile device; a compass reading of the mobile device; a voice call state of the mobile device; a video call state of the mobile device; a headphone use state of the mobile device; a battery level of the mobile device; and a network signal coverage level of the mobile device.

In various embodiments adjusting, by advertising device, the advertising rate charged to the advertiser for the advertising content presented by the advertising device based on the obtained information indicative of the state of attentiveness of the user of the mobile device may include increasing, by the advertising device, the advertising rate when the information indicative of the state of attentiveness indicates that the user is likely to be attentive to the advertising content. In various embodiments adjusting, by the advertising device, the advertising rate charged to the advertiser for the advertising content presented by the advertising device based on the obtained information indicative of the state of attentiveness of the user of the mobile device may include reducing, by the advertising device, the advertising rate when the information indicative of the state of attentiveness indicates that the user is unlikely to be attentive to the advertising content.

In various embodiments detecting, by the advertising device, a presence of a mobile device in proximity to the advertising device may include assigning, by advertising device, a target grade for the mobile device based on one or more of: a make of the mobile device; a model of the mobile device; applications installed on the mobile device, or a language of the mobile device. Some embodiments may further include adjusting, by the advertising device, the advertising content based on the assigned target grade of the mobile device. Some embodiments may further include adjusting, by the advertising device, the advertising rate charged to the advertiser for the advertising content presented by the advertising device based on the obtained information indicative of the state of attentiveness of the user of the mobile device may include adjusting, by the advertising device, one or more of: the advertising rate and the advertising content, based on one or more of the obtained information and the assigned target grade of the mobile device.

Some embodiments may further include assigning, by the advertising device, a target grade for each of a plurality of mobile devices in proximity to the advertising device based on one or more of: a make of each mobile device; a model of each mobile device; applications installed on each mobile device, and a language of each mobile device, calculating, by the advertising device, an aggregate target grade for all of the plurality of mobile devices, and adjusting, by the advertising device, one or more of: the advertising rate and the advertising content, based on the aggregate target grade.

Further embodiments methods for adjusting an advertising rate charged to an advertiser for advertising content presented by an advertising device may include receiving, by a server, device characteristics from of a plurality of mobile devices in proximity to the advertising device, determining, by the serve, a state of attentiveness of users of the plurality of mobile devices to the advertising device based on the received device characteristics, and adjusting, by the server, the advertising rate charged to the advertiser for the advertising content presented by the advertising device based on the determined state of attentiveness of the users of the plurality of mobile devices. In such embodiments, the characteristics for each mobile device of the plurality of mobile devices may include information associated with one or more of: a device ID of the mobile device, a device type of the mobile device, a distance of the mobile device from the advertising device; a position of the mobile device relative to a field of view of a display of the advertising device; a position of the mobile device relative to a field of audibility of an audio output of the advertising device; a placement of the mobile device in a pocket of the user; a state of interaction of the user with the mobile device; a movement of the mobile device; a compass reading of the mobile device; a voice call state of the mobile device; a video call state of the mobile device; a headphone use state of the mobile device; a battery level of the mobile device; and a network signal coverage level of the mobile device.

In some embodiments adjusting, by the server, the advertising rate charged to the advertiser for the advertising content presented by the advertising device based on the determined state of attentiveness of the users of the plurality of mobile devices may include increasing, by the server, the advertising rate when the determined state of attentiveness indicates that the users are likely to be attentive to the advertising content. In some embodiments adjusting, by the server, the advertising rate charged to the advertiser for the advertising content presented by the advertising device based on the determined state of attentiveness of the users of the plurality of mobile devices may include reducing, by the server, the advertising rate when the determined state of attentiveness indicates that the users are unlikely to be attentive to the advertising content.

Some embodiments may further include assigning, by the server, a target grade for each mobile device of the plurality of mobile devices based on one or more of the device type of the mobile device, applications installed on the mobile device, or a language of the mobile device. Such embodiments may further include adjusting, by the server, the advertising content based on the assigned target grade of the mobile device. In some embodiments, adjusting, by the server, the advertising rate charged to the advertiser for the advertising content presented by the advertising device based on the determined state of attentiveness of the users of the plurality of mobile device may include adjusting, by the server, one or more of: the advertising rate and the advertising content, based on one or more of the device characteristics and the assigned target grade of the plurality of mobile devices.

Further embodiments include advertising devices, such as displays, radios, sound systems, etc. having a processor configured with processor-executable instructions configured to perform operations of advertising device methods described above. Further embodiments include a server having a communication framework interface and a processor configured with processor-executable instructions configured to perform operations of server methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1A is a system diagram illustrating components of an advertising and billing system suitable for use in the various embodiments.

FIG. 1B is a diagram illustrating a conventional advertising device and ambient noise level ad content schedule.

FIG. 1C is a diagram illustrating and advertising device and mobile device characteristic based advertising and billing in the various embodiments.

FIG. 2A is a diagram illustrating an advertising device and mobile devices in different positions relative to the advertising device in the various embodiments.

FIG. 2B is a diagram illustrating a level of attentiveness to an advertising device for a user of a mobile device that is not in use in the various embodiments.

FIG. 2C is a diagram illustrating a level of attentiveness to an advertising device for a mobile device user who based on the user's position relative to the advertising device.

FIG. 2D is a diagram illustrating a level of attentiveness to an advertising device for a mobile device user engaged in various interactions with the mobile device.

FIG. 2E is a diagram illustrating a level of attentiveness to an advertising device for a mobile device user based on detecting visual, audio or other patterns output by the mobile device.

FIG. 3A is a message flow diagram illustrating communication networking framework messages between an advertising device and mobile devices for performing mobile device discovery, determining mobile device characteristic information and other information in the various embodiments.

FIG. 3B is a message flow diagram illustrating communication networking framework messages between an advertising device and mobile devices for determining attentiveness and performing billing based on mobile device characteristic information and other information in the various embodiments.

FIG. 4A is a process flow diagram illustrating an embodiment method for performing billing for ad content on an advertising device based on characteristics such as attentiveness.

FIG. 4B is a process flow diagram illustrating an embodiment method for determining a user visual attentiveness level based on mobile device characteristics.

FIG. 4C is a process flow diagram illustrating an embodiment method for determining a user audio attentiveness level based on mobile device characteristics.

FIG. 4D is a process flow diagram illustrating an embodiment method for determining mobile device orientation and user attentiveness level based on mobile device visual pattern reception characteristics.

FIG. 4E is a process flow diagram illustrating an embodiment method for determining mobile device orientation and user attentiveness level based on mobile device audio pattern reception characteristics.

FIG. 5A-FIG. 5C are process flow diagrams illustrating embodiment methods for billing based on mobile device characteristics and attentiveness.

FIG. 6 is a component diagram of an example mobile device suitable for use with the various embodiments.

FIG. 7 is a component diagram of an example mobile device suitable for use with the various embodiments.

FIG. 8 is a component diagram of an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The various embodiments provide communication systems that enable advertising rates for an advertising display mobile device presenting ad content in a public location that is populated by users with wireless mobile communication mobile devices to be dynamically set and assessed based on indications of how likely individuals are perceiving and paying attention to the ad. The various embodiments may use distributed, dispersed or ad-hoc networks among various communication mobile devices to communicate mobile device location, activity and characteristic data to an advertising device. The mobile device location, activity and characteristics may be used to determine a likelihood or degree of attentiveness of the mobile device user to the advertising device and the ad content. The number of attentive users and other information (e.g., whether the user's mobile device is a premium mobile device, an economy mobile device, etc.) may be used to determine an advertising rate to charge an advertiser for the ad content displayed on the advertising device.

The term “mobile device” is used herein to refer to any form of mobile computing and communication device that may be carried by a person, such as a smartphone, tablet computer, smartwatch, laptop computer and the like that include communication circuitry and a processor configured to perform the operations of the various embodiments.

The term “advertising device” is used herein to refer to any form of advertising presentation device that is configured to present ad content as well as perform operations of the various embodiments. Examples of advertising devices include televisions, electronic displays, radios, loud speakers, billboards, and electronic billboards.

The terms “framework,” “networking framework” and “communication networking framework” as used herein refer interchangeably to a communications framework, an applications framework, and organized systems of communication and application-interaction protocols and commands for facilitating mobile device-to-mobile device (e.g., peer-to-peer or “P2P”) and application-to-application communications, interactions and control. A networking framework may be implemented as a collection of Application Programming Interfaces (APIs), Software Development Kits (SDSKs), and other application or system software that collectively provide standard mechanisms and interface definitions to enable interfacing between controlling and controlled mobile devices coupled through a communication network that may be an ad-hoc network. The various APIs and SDKs may provide high-level access (e.g., from an application layer) to functions that would normally be accessed or controlled at a lower layer in a software architecture. Such functions may include, but are not limited to, ad-hoc networking, security, pairing, mobile device discovery, service discovery, platform transparency, radio access control, message formatting, message transmission, message reception and decoding, and so on. An example of a comprehensive networking framework is the AllJoyn™ Core Framework initially developed by Qualcomm Innovation Center and presently hosted by the Allseen Alliance.

An AllJoyn Core Framework may include a set of service frameworks that are simple and enable users to interact with nearby similarly configured computing mobile devices. An example of a set of service frameworks includes Mobile device Information & Configuration (e.g., “About”) in which the mobile device broadcasts information such as mobile device type, manufacturer and serial numbers, and Onboarding that allows objects to be easily connected to each other (e.g., P2P) or through an intermediary mobile device (e.g., an access point) to the user's network. A set of service frameworks may provide Notifications that enable objects to broadcast and receive basic communications (e.g., text, image/video, audio, control, status). A set of service frameworks may allow the user to assign a name and password to the mobile device.

The embodiments may utilize a networking framework (e.g., AllJoyn) that enables various communication mobile devices to inform the advertising device about their characteristics. One or more of a variety of mobile device characteristics may be used to determine whether the user of a mobile device is likely to be attentive to the audiovisual content displayed on the advertising device. The likely attentiveness of users may be used to adjust the advertising rate charged to the advertiser. Other mobile device characteristics, such as whether the mobile device is a premium mobile device (e.g., a smartphone) or an economy mobile device, may be used to infer the demographics or socio-economic characteristics of the mobile device user and thereby select ad content, determine advertising rates, etc.

In some embodiments, the position of the mobile device relative to the advertising device may be determined and used as an indication of the user's ability to successfully perceive ad content, and thus the likely attentiveness of the user to the ad. For example, when the mobile device is determined to be in front of display of the advertising device, the level of visual attentiveness of the user is likely to be higher than when the mobile device is determined to be behind the display of the advertising device. In some embodiments, the position or location of the mobile device may be determined through information obtained by a Global Navigation Satellite System (GNSS) receiver (e.g., a Global Positioning System (GPS) receiver), such as geographic coordinates of the mobile device. The coordinate information may allow the advertising device to determine the relative position of nearby user mobile devices. In some embodiments, the relative location of the mobile device with respect to the advertising device may be determined through P2P communications information, such as using trilateration, triangulation, or other relative position determining mechanisms. Additional information about the orientation of the mobile device relative to the advertising device may be obtained from a compass or accelerometer of the mobile device.

In some embodiments, the level of interactions by the user with the mobile device may be determined or inferred by information provided by the mobile device related to the user's interactions with the mobile device. For example, if users are heavily engaged with their mobile devices, they are less likely to be attentive to the ad content presented on the advertising device. Indications of interactions with a mobile device may include output from accelerometers, keyboard interactions, and an application in use (e.g., a texting app, a game app, other app, etc.) is being used. In some embodiments, when accelerometer data is consistent with user usage, general interactions with the mobile device may be presumed. In some embodiments, data from the mobile device may indicate that the mobile device is in the user's pocket or in a “pocket mode” may be detected. For example, various sensors on the mobile device and other information may be used to detect when users have placed their mobile devices in their pocket, and implement a pocket mode that reduces the instance of inadvertent dialing. Such mobile devices may communicate that they are in the pocket mode to the advertising device, enabling the advertising device to infer that the user is not paying attention to the mobile device and thus more available to pay attention to presented ad content. In some embodiments, the level of interactions with the mobile device may be determined by indications that the user is engaged in a call, as well as whether it is a voice call (in which case the user may view but not hear the ad) or a video call (in which case the user will neither see nor hear the ad). Data regarding such indications of interactions may be provided through the communications framework.

In some embodiments, mobile device interactions may be detected or reported for a user by the user's mobile communication mobile device (e.g., a smartphone, tablet computer, etc.) that are in proximity of the advertising device (e.g., a smart TV) via an ad hoc communication network. Such a communication network may be a peer-to-peer networking framework (e.g., AllJoyn) that is supported using WiFi, NAN (Neighborhood Area Network), LTE Direct, Bluetooth, Bluetooth Low Energy, or another wireless communication protocol. In some embodiments, an application may be installed on the user mobile communication mobile devices and on advertising display mobile devices that may facilitate the exchange of mobile device characteristic information. The application on the user mobile communication mobile devices may track attentiveness information and communicate that information to the advertising device, or other network mobile device that can provide the information to a billing server. In some embodiments, the billing server may also be connected to the communication framework and may receive attentiveness information directly from user mobile devices.

In some embodiments, the advertising device may determine the degree to which nearby persons can perceive (see, hear or see and hear) ad content presented on the advertising device (sometimes referred to as “content perceptibility,” “content viewability” or “content audibility”) based on proximity and relative location of the mobile devices to the front, back, sides, and distance from the advertising device. Further, levels of ambient noise may be measured in order to determine a degree of audibility of audio ad content being output by the advertising device. The advertising device may receive information identifying the mobile devices that are close by and determine the distance of each mobile device to the advertising device.

The likely attentiveness of users of the mobile devices may be assessed using the determined proximity of the mobile devices. Factors affecting likely attentiveness based on proximity may be related to content perceptibility displayed on the advertising device, such as the size of the display screen, the level of the audio, ambient lighting in the venue, ambient noise in the venue, and so on. These factors may influence the ability of people to be able to hear and/or see the ad content being presented by the advertising device. Thus, a large display (e.g., a tickertape marquees or a large screen TV) that a person could see from a relatively long distance may have a large visual perceptibility distance and a moderate audio perceptibility distance depending on volume levels. The relative position of individuals (as determined based on information from their mobile devices) may also impact likely attentiveness. For example, while a mobile device may be close to an advertising device, the mobile device and thus the owner of the device may be behind the mobile device leading to compromised visual perceptibility. However, the same person (determined based on information from the person's mobile device) may be close enough to hear the audio from the mobile device based the volume level of the audio content compared to the ambient noise.

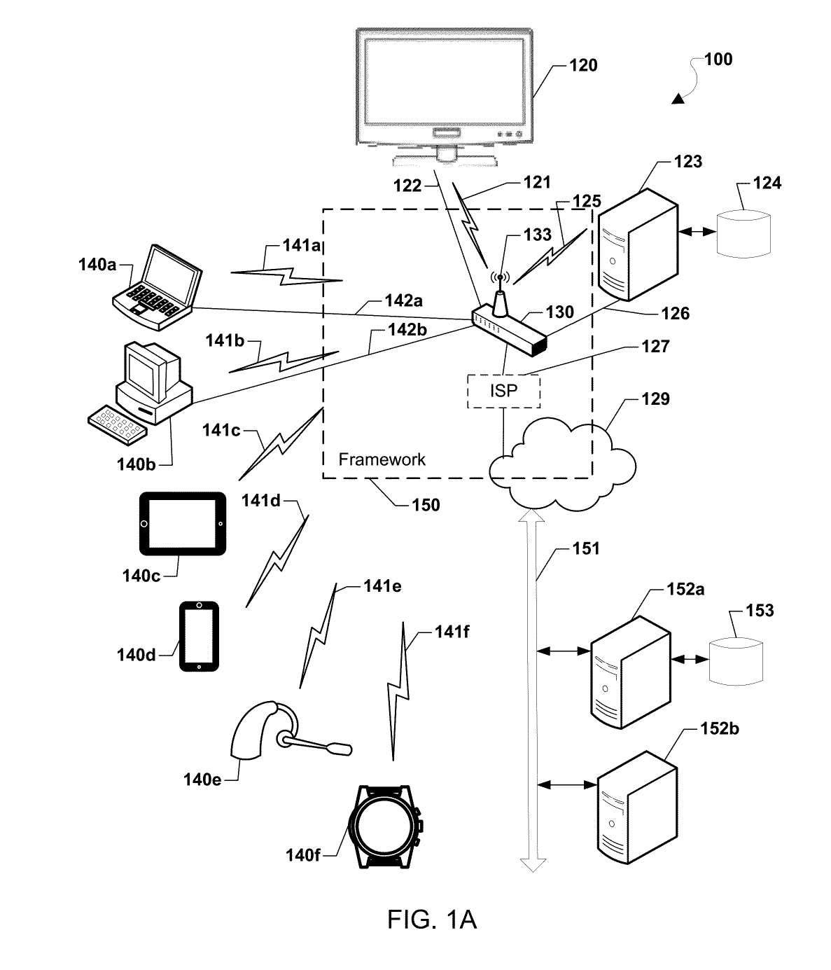

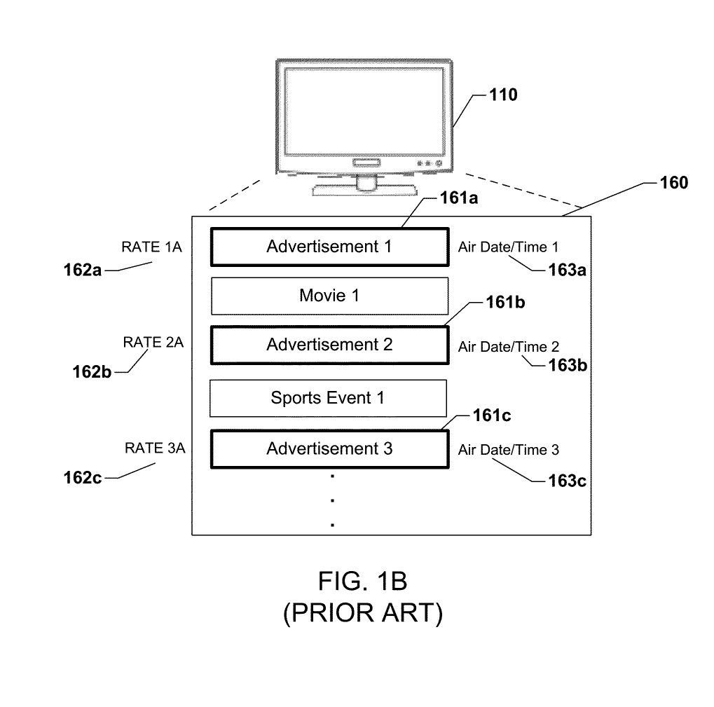

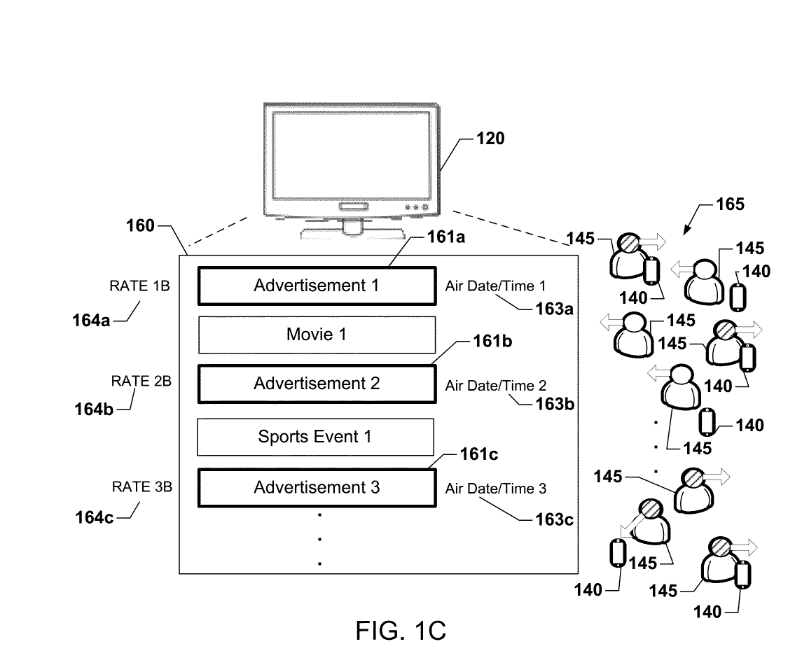

The various embodiments may be implemented within a variety of electronic communication environments, such as private networks, public networks, ad hoc (i.e., mobile device-to-mobile device) networks, or combinations of private, public and ad hoc networks. An example communication network 100 is illustrated in FIG. 1A. In an embodiment, the communication network 100 may include computing mobile devices 140a-140f, which may be mobile devices. The computing mobile devices 140a-140f may be premium mobile devices, wearable mobile devices, tablet mobile devices, economy mobile devices, and so on, which may be carried by a person to a location where content is being presented by an advertising device 120. In some embodiments, a computing mobile device, such as the mobile device 140b may be a stationary computing mobile device that may have visual/audible access to the advertising device 120.

Mobile device characteristic determination and billing may be conducted based on the presence of one or more mobile devices 140a-140f, which may enter into or otherwise be positioned in proximity to advertising device 120, which is operating in an environment with a communication framework 150. Mobile devices 140a-140f may be carried by a user and thus be with the user when he/she is in proximity of the advertising device 120. The user may or may not be in a position to observe ad content on an advertising device. Further, depending on the level of engagement with the computing mobile devices 140a-140f, the user may be in a position to observe the audio and/or video ad content of the advertising device but may be inattentive to the content due to mobile device engagement. For example, the computing mobile devices 140a-140f may be configured to send or receive voice calls, video calls, social media content, email messages, SMS messages, Instant Messages. Further, the computing mobile devices 140a-140f may be configured with applications, such as games, or other applications, which may engage the user to the point that the user's attentiveness to the content from the advertising device 120 is diminished. In the various embodiments, the computing mobile devices 140a-140f may include without limitation, a laptop computing mobile device 140a, a desktop computing mobile device 140b, a tablet computing mobile device 140c, a smart phone 140d, a wireless earpiece 140e, a wireless media-capable watch 140f, and so on. The computing mobile devices 140a-140f may be coupled wirelessly to an access point 130, through wireless links 141a-141f. In some instances, a wired link, such as links 142a and 142b may be established between the computing mobile devices 140a and 140b and the access point 130. In other embodiments, the computing mobile devices 140a-140f may be coupled through mobile device to mobile device (D2D) or point to point (P2P) communications. The computing mobile devices 140a-140f may also be premium, or non-premium mobile devices, which may provide information that supports an inference as to the socio-economic status of the user.

In various embodiments, the advertising device 120 may be any type of device configured to present ad content, such as television screen in a home, or a public place, such as in a workplace break room, electronic billboard, mobile electronic billboard, and so on. In some instances, the advertising device 120 may be a display device of a user that is viewable by others, such as a display in an automobile. In some embodiments, the advertising device 120 may be coupled to an access point 130 through a wireless link 121 and/or a wired link 122.

In some embodiments, the content presented on the advertising device 120 may be provided by and/or through an independent service provider 127, such as through the access point 130. The independent service provider 127 may be a provider of subscription based content such as a telephone, cable, or Internet provider, or combinations of these subscription based services. In other embodiments content may be provided from a server 123, such as a private server for a private portion of the communication network 100. The server 123 may also provide billing services. In some embodiments, a separate billing server may additionally or alternatively be used. The server 123 may be coupled to the access point 130 through a wireless link 125 and/or a wired link 126. The server 123 may have an integrated mass storage element 124 or elements. Alternatively or in addition, the mass storage element 124 may be external to the server 123. The communication network 100 may further include a connection to a public network, such as the Internet 129, such as through the independent service provider 127. In some embodiments, the content may include content obtained through the Internet 129. The communication network 100 may further include servers 152a and 152b that may be coupled to or be integrated with one or more mass storage elements 153. The servers 152a and 152b may be remote servers associated with providing ad content, billing services, or may be remote servers associated with third party content.

In the various embodiments, communication, control and interactions between the various mobile devices and content displaying mobile devices may be facilitated using the networking framework 150, which may be a communication networking framework, such as an AllJoyn framework. The communication networking framework 150 may provide platform independent API calls that allow the computing mobile devices to advertise presence, communicate capabilities, give and receive control commands, status messages, and so on. For example, based on information received via the networking framework 150 from one of the computing mobile devices 140a-140f, the advertising device 120 may determine factors such as attentiveness and may provide advertising rates based on attentiveness as described in further detail herein.

In conventional advertising, an example of which is illustrated in FIG. 1B, a content presentation mobile device 110 may provide programming content, such as a movie (Movie 1), a sports event (Sports Event 1), etc. During the presentation of the programming content, advertisements may be interspersed in the programming content. In some embodiments, the content presentation mobile device 110 may be a dedicated advertising display that displays only advertising. In the example illustrated in FIG. 1B, a first advertisement 161a is presented at a given date/time 163a. An advertising rate 1A 162a may be charged to the advertiser for display of the first advertisement 161a based on the date/time 163a of airing, run length, rating of underlying programming content, and so on. A second advertisement 161b may air at a date/time 163b, at another advertising rate 2A 162b. A third advertisement 161c may air at a date/time 163c, at an advertising rate 3A 162c, and so one. The advertising rates 163b and 163c may similarly be charged based on factors such as the date/time of airing, run length, rating of underlying programming content, etc. Other charging methods may include block advertising, where a flat rate is charged for advertising, which may appear at any time, such as based on space availability. Other factors may also influence the advertising rate charged to the advertiser such as the predicted demographic of the audience. However, conventional advertising systems fail to account for the circumstances of individual advertising display events, such as actual audience make up, whether those present can actually see and/or hear ad content, and other factors, which lead to the possibility that advertisers pay a premium rate regardless of the actual circumstances.

In various embodiments, as illustrated in FIG. 1C an advertising device 120 may present ad content to an audience 165 that contains various users 145, some (or all) of which may have mobile devices 140. Additional ones of the users 145, with our without mobile device 140, may move into the audience 165. Members of the audience 165, such as ones of the users 145 may leave the area of the advertising device 120. As the mobile devices 140 enter into proximity to the advertising device 120, the mobile devices 140 may become interconnected with the advertising device 120, such as through the framework 150 (not shown). In some embodiments the mobile devices 140 and the advertising device 120 may be connected to each other through D2D or P2P connections through the framework 150, or facilitated by the framework 150. The advertising device 120 may be coupled to the mobile devices 140 and a server, such as a billing system and/or advertising system server (not shown), through the framework 150. The framework 150 may enable mobile device characteristics of the mobile devices 140 to become known.

When the mobile devices 140 register with the framework 150, information about the type of mobile device, the mobile device capabilities, the location of the mobile device, the status of the mobile device, and other information may become available and may be used to assess advertising rates, content selection, and so on for the ad content displayed on the advertising display mobile device 120. For example, the type of the mobile device 140 may indicate a likely socio-economic status of the associated user 145, which may affect ad content selection. The location of the mobile device 140 may indicate whether it is possible for the user 145 to view the display of the advertising device 120, which may affect the advertising rate charged to the advertiser. The status of the mobile device may indicate a degree of interactions with the mobile device 140 by the use 145, which may also affect the advertising rate charged to the advertiser.

Additional interactions through the framework 150 may allow more detailed conditions of the mobile devices 140 to be determined, such as whether the mobile device is engaged in a voice or video call, whether the mobile device is being interacted with by a user, whether the mobile device is inactive, etc. By determining mobile device characteristics of the various mobile devices 140, information may be obtained that supports inferences regarding the socio-economic status of and the likely attentiveness of users 145, who are associated with the mobile devices 140. Other inferences may be possible.

The advertising device 120 may display the first advertisement 161a at the date/time 163a, which may be during or adjacent to a programming content time slot, such as a movie time slot. However, because inferences may be made regarding the audience 165, such as the attentiveness of users 145 based on mobile device characteristics of the mobile devices 140, an advertising rate 1B 164a may be charged to the advertiser. Further inferences may be made regarding the socio-economic status of the users 145 based on the type of the mobile devices 140 (e.g., premium mobile device users may find premium ad content appealing), ad content may be selected to appeal to members of the audience 165 based on these inferences.

Using the inferences that may be made regarding the content perceptibility by those near the advertising device, the attentiveness of those near the advertising device, the economic status of those near the advertising device, etc. the advertising rate 1B 164a may more accurately reflect the actual make-up, and attentiveness of the audience 165. For example, if only a small percentage of the audience 165 is likely to be attentive to the ad content displayed on the advertising device 120, such as based on a detected location or level of interactions with mobile devices 145, a reduced rate may be charged as the advertising rate 1B 164a. If a significant percentage of the audience 165 is likely to be attentive to the ad content displayed on the advertising device 120, such as based on a detected location or level of interactions with mobile devices 145, an increased rate may be charged as the advertising rate 1B 164a.

The advertising device 120 may display the second advertisement 161b at the date/time 163b that may be during or adjacent to a programming content time slot, such as a sports event time slot. However, because inferences may be made regarding the audience 165, such as the attentiveness of users 145 based on mobile device characteristics of the mobile devices 140, an advertising rate 2B 164b may be charged to the advertiser. The advertising device 120 may display the third advertisement 161c at the date/time 163c, which may be during or adjacent to a further programming content time slot. However, because inferences may be made regarding the audience 165, such as the attentiveness of users 145 based on characteristics of the mobile devices 140, an advertising rate 3B 164c may be charged to the advertiser. In some embodiments, the advertising display mobile device 120 may be a dedicated advertising display mobile device and may continuously or periodically display only advertising or other promotional content. In such an embodiment, the mobile device characteristics of the mobile devices 140 of the users 145 in the audience 165 may be continuously or periodically determined. Based on the mobile device characteristics, ad content may be selected and/or advertising rates may be billed to the advertiser based on likely attentiveness of the users 145 making up the audience 165.

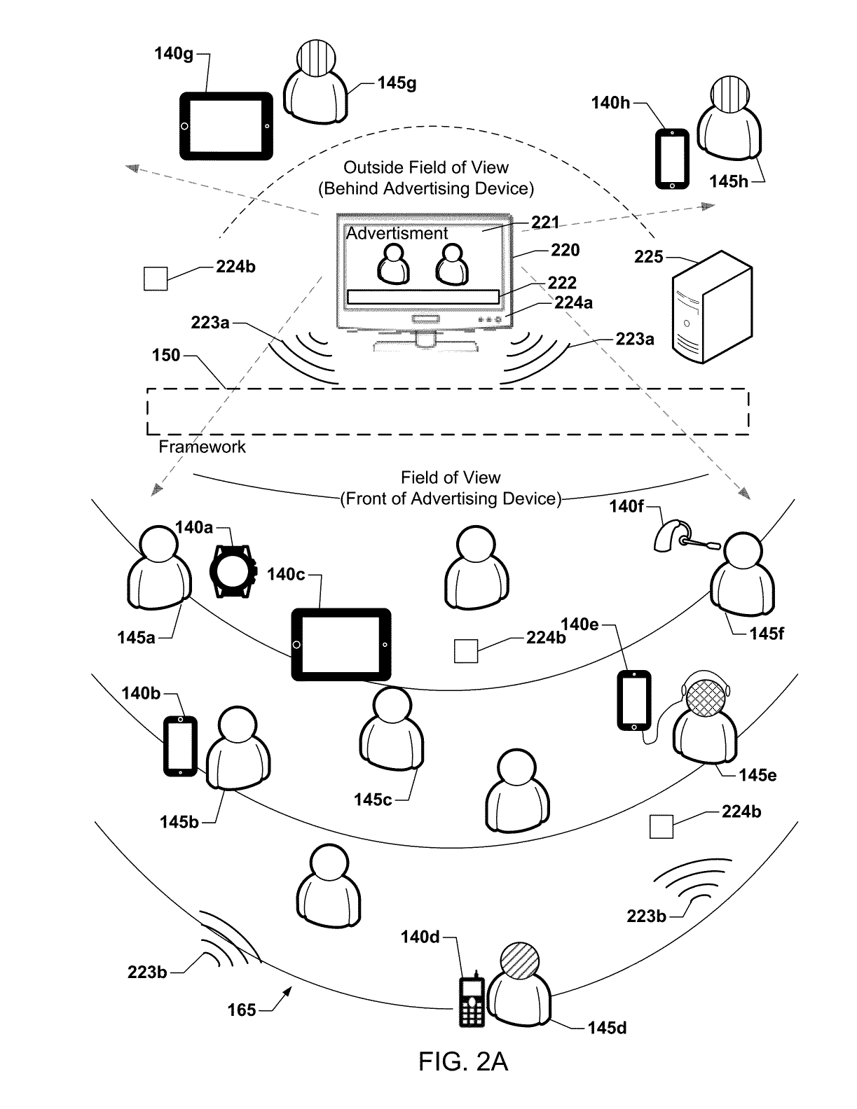

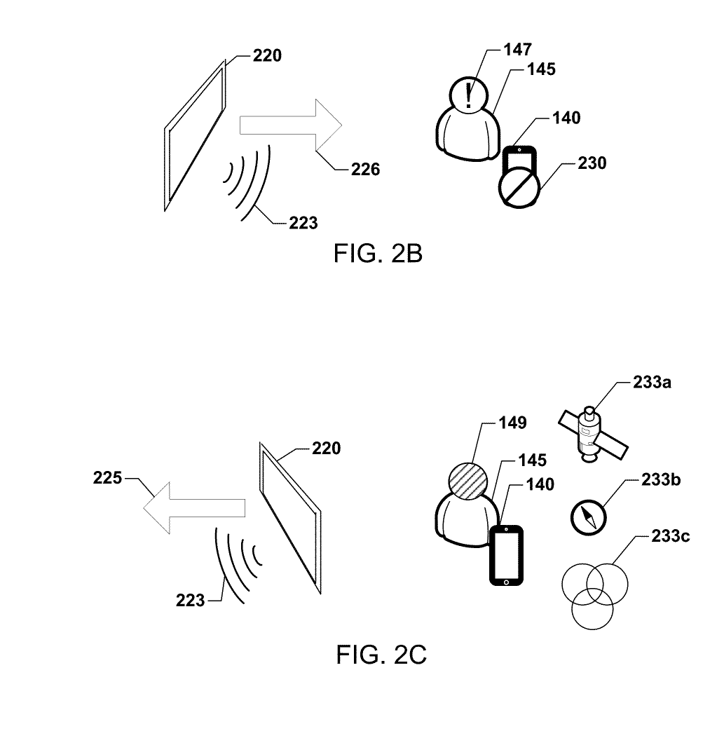

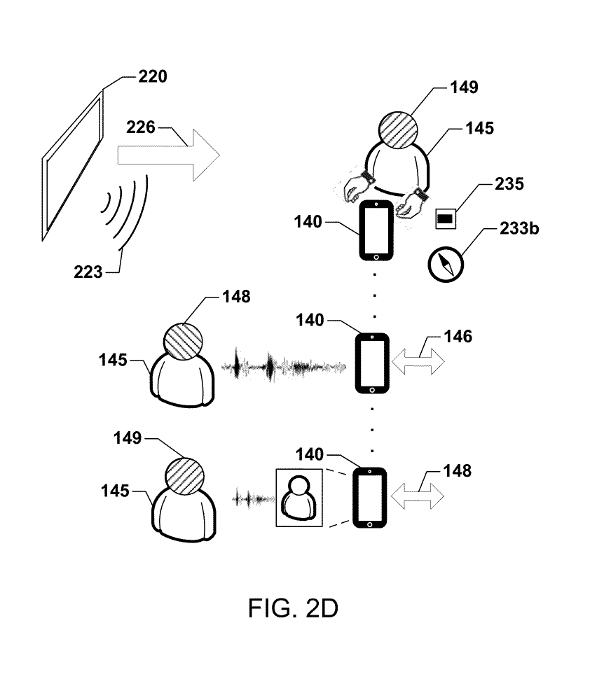

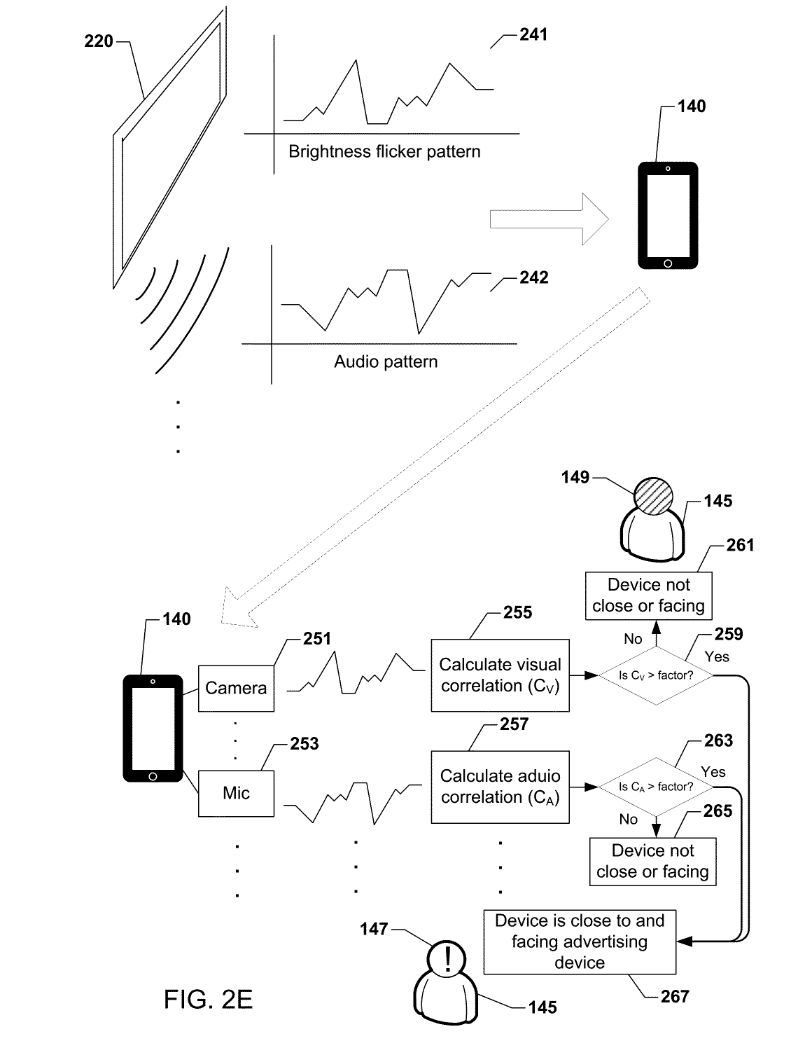

In the various embodiments, an advertising display mobile device, such as the advertising device 220 illustrated in FIG. 2A, may be in a setting such as a public or semi-public (e.g., workplace) area. The advertising device 220 may have a basic presentation display area 221 on which a main program is being presented. The advertising device 220 may further include a ticker display area 222 on which information that is supplementary or completely unrelated to the main program may be displayed in a cycling fashion, such as informative text that scrolls through the ticker display area 222. The advertising device 220 may play sound from a speaker based to generate an audio signal 223a associated with the ad content. The output level of the audio signal 223a may be controlled, or may be provided at a known volume level. The advertising device 220 may be configured with a microphone 224a that may further detect the level of ambient noise 223b in the environment. In other embodiments, one or more external audio sensors 224b may be placed in the environment. The external audio sensors 224b may be configured to communicate with the advertising device 120, or other mobile device or mobile devices, through the framework 150.

The advertising device 220 may be located in an area where the computing mobile devices 140a-140h may come into and move out of proximity to the advertising device 220. For example, as users 145a-145h forming at least part of the audience 165 move into or out of proximity to the advertising device 220, the mobile devices 140a-140h may move with respective ones of the users 145a-145h. Other persons without mobile devices may also be present in the audience 165. When a mobile device 140 moves within radio range of the advertising device 220, the mobile device 140 may be discovered by the advertising device 220 and/or the mobile device 140 may discover the advertising device 220, such as through commands, requests, messages, and so on, associated with the communication networking framework 150. The advertising device 220 through the communication networking framework 150 may exchange commands, requests, and messages with the mobile devices 140a-140h. The messages may be transmitted, received, exchanged between the mobile devices 140a-140h and the advertising device 220 to facilitate communication, control, and interactions between the mobile devices. For example, the advertising device 220 may receive an advertisement of presence of one or more the mobile devices 140a-140h through a message associated with the communication networking framework 150. The message may provide mobile device characteristics of each of the mobile devices 140, such as the type of mobile device, the mobile device capabilities, the location of the mobile device, the status of the mobile device, and other information.

Alternatively or additionally, the advertising device 220 may obtain information about the proximity of the mobile device 140, such as through calculating the range of the radio signals received from the mobile device 140, from location coordinates (e.g., GPS) associated with the mobile device 140, from P2P or D2D relative location information, and so on. Based on the proximity or location information, the mobile devices 140a-140h may have full, partial, limited or obstructed view of the advertising device 220. Based on the proximity or location information, the mobile devices 140a-140h may also have full, partial, limited or obstructed hearing of the presentation content audio.

The ability for the mobile devices 140a-140h to hear the audio from the advertising device 220 may be further impaired by the ambient noise 223b. In other embodiments, users such as the user 145e of the mobile device 140e may be wearing headphones, which impair the audible attentiveness of the user 145e. Other users, such as the use 145d of the mobile device 140d may be facing away from the advertising device 220 and thus may have impaired visual attentiveness to the advertising device 220. Still other users, such as the user 145g of the mobile device 140g and the user 145h of the mobile device 140h may be positioned behind the advertising device 220, which may impair at least the visual attentiveness of the users 145g and 145h.

In the various embodiments, the advertising device 220 may determine a level of likely attentiveness to the ad content based on the relative position of the computing mobile devices 140a-140h. The advertising device 220 may provide the location based attentiveness information to a server 225, such as a billing server or advertising server, which may increase or reduce the advertising rates charged to the advertiser based on the attentiveness information. In addition to the location based attentiveness information, other attentiveness information may be determined.

For example, as illustrated in FIG. 2B, the mobile device characteristics obtained when the mobile device 140 registers with the framework 150, or obtained after registration, may be used to determine that the mobile device 140 is inactive. For example, an inactivity 230 of the mobile device 140 may determined based on detecting from the characteristic information, or other information, that the mobile device 140 is in the pocket of the user 145. The inactivity 230 of the mobile device 140 may indicate that the user 145 is not interacting with the mobile device 140 and is therefore likely to be in an attentive state 147. Thus, subject to position information, the user 145 is likely to be attentive to the visual content 226 and the audio content 223 of the advertising presented from the advertising device 220.

In the various embodiments, as illustrated in FIG. 2C, position information from a GPS system 233a, a mobile device compass 233b, or trilateration, triangulation, or other relative position information 233c for the mobile device 140 may indicate that the user 145 is behind the advertising device 220. The information may indicate that the user 145 is likely to be in an inattentive state 149. Thus, based on the position information, the user 145 is likely to be inattentive to the visual content 226 and the audio content 223 of the advertising presented from the advertising device 220.

Further in the various embodiments, as illustrated in FIG. 2D, interactions by the user 145 with the mobile device 140 may be detected. For example, the mobile device characteristic information obtained during or after registration with the framework 150 may indicate that the user 145 is interacting with the mobile device 140. In some embodiments, interactions may be detected or determined from the mobile device characteristic information based on output from a mobile device accelerometer 235. In some embodiments, keyboard activity may be detected or determined from the mobile device characteristic information. In some embodiments, the use of an application may be detected or determined from the mobile device characteristic information. In some embodiments, a compass 233b may be used to additionally detect an orientation of the mobile device 140 with respect to the advertising device 220 and/or interactions with the mobile device.

As further illustrated in FIG. 2D, interactions by the user 145 with the mobile device 140 may be detected or determined from the mobile device characteristic information based on active voice call 146 or video call 148. In the case of a voice call 146, the user 145 may be partially attentive to the content of the advertising device 220 based on the likelihood that the user 145 can see the visual content 226, but may not be able to hear the audio content 223. In the case of a video call 148, the user 145 may be inattentive to the content of the advertising device 220 based on the likelihood that the user 145 cannot see the visual content 226 or hear the audio content 223. In the illustrated examples, the user 145 is likely to be in an inattentive state 149 or a partially inattentive state 148.

Further in the various embodiments, as illustrated in FIG. 2E, information that may assist in determining the likely attentiveness of the user 145 may be determined by detecting a signal pattern embedded in the visual, audio or other output of the advertising device 220. For example, the advertising device 220 may output a visual pattern 241, such as a “flicker” pattern embedded along with the visual content 226. The visual pattern 241 may include a brightness modulation pattern that is generally imperceptible to the user 145. The advertising device 220 may alternatively or additionally output an audio pattern 242, such an audio modulation pattern embedded along with the audio content 223. The audio pattern 242 may include an audio frequency or amplitude envelope modulation pattern, a tonal pattern included with the advertising audio, an ultrasound pattern, or other audio pattern that is generally imperceptible to the user 145. The mobile device 140 may receive the visual pattern 241 through a camera mobile device 251. The mobile device 140 may receive the audio pattern through a microphone mobile device 253, which in some embodiments may be configured to receive ultrasonic signals.

In block 255, a processor of the mobile device 140, may be configured to calculate a visual correlation C_{V} between the received visual content 226 and a reference (e.g., the original visual pattern 241). In determination block 259, the processor of the mobile device 140 may determine whether the visual correlation C_{V} is greater than an acceptable correlation factor, such as a percent or degree of correlation. In some examples, the correlation factor may be around an 80% correlation, although other correlation levels are possible. In response to determining that the visual correlation C_{V} is not greater than the acceptable correlation factor (i.e., determination block 259=“No”), the processor of the mobile device 140 may determine that the mobile device is not close to or facing the advertising device 220 in block 261 and that the user 145 is likely to be in an inattentive state 149. In response to determining that the visual correlation C_{V} is greater than the acceptable correlation factor (i.e., determination block 259=“Yes”), the processor of the mobile device 140 may determine that the mobile device is close to and/or facing the advertising device 220 in block 267 and that the user 145 is likely to be in the attentive state 147. The determination of the attentiveness state 147 or the inattentiveness state 149 may be subject to other attentiveness determinations.

In block 257, the processor of the mobile device 140, may be configured to calculate an audio correlation C_{A} between the received audio content 223 and a reference (e.g., the original audio pattern 242). In determination block 263, the processor of the mobile device 140 may determine whether the audio correlation C_{A} is greater than an acceptable correlation factor, such as a percent or degree of correlation. In some examples, the correlation factor may be around an 80% correlation, although other correlation levels are possible. In response to determining that the audio correlation C_{A} is not greater than the acceptable correlation factor (i.e., determination block 263=“No”), the processor of the mobile device 140 may determine that the mobile device is not close to or facing the advertising device 220 in block 265 and that the user 145 is likely to be in an inattentive state 149. In response to determining that the audio correlation C_{A} is greater than the acceptable correlation factor (i.e., determination block 265=“Yes”), the processor of the mobile device 140 may determine that the mobile device is close to and/or facing the advertising device 220 in block 267 and that the user 145 is likely to be in the attentive state 147. The determination of the attentiveness state 147 or the inattentiveness state 149 may be subject to other attentiveness determinations.

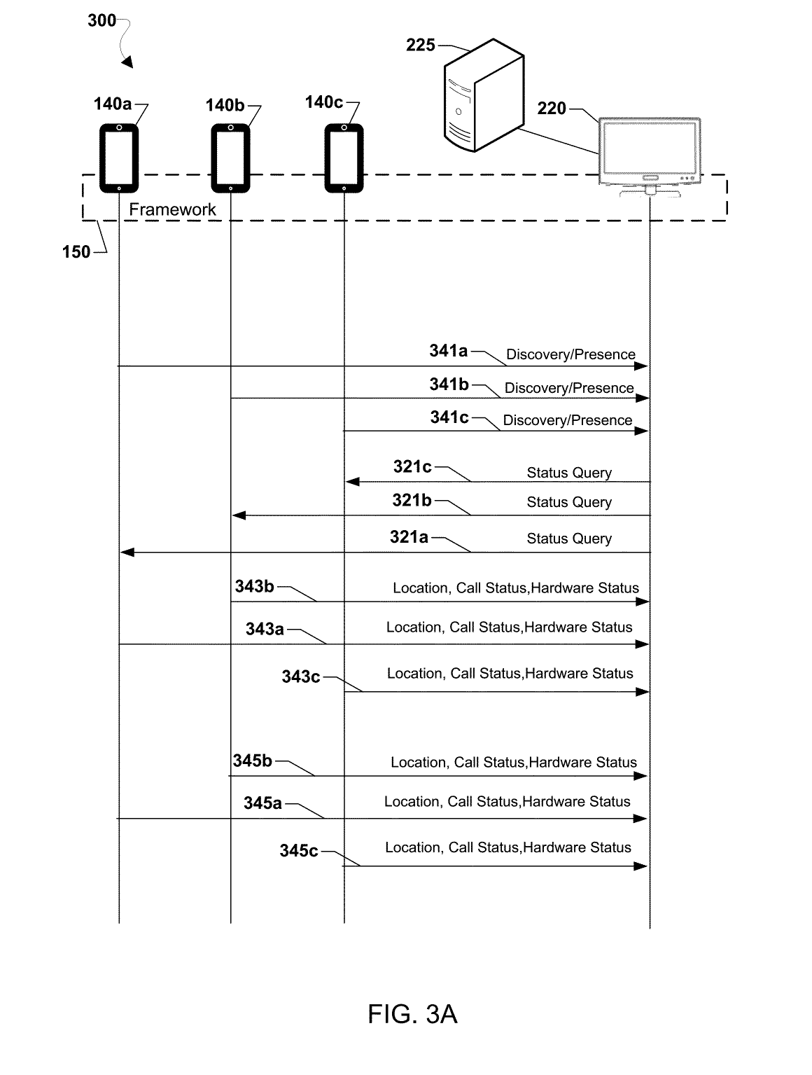

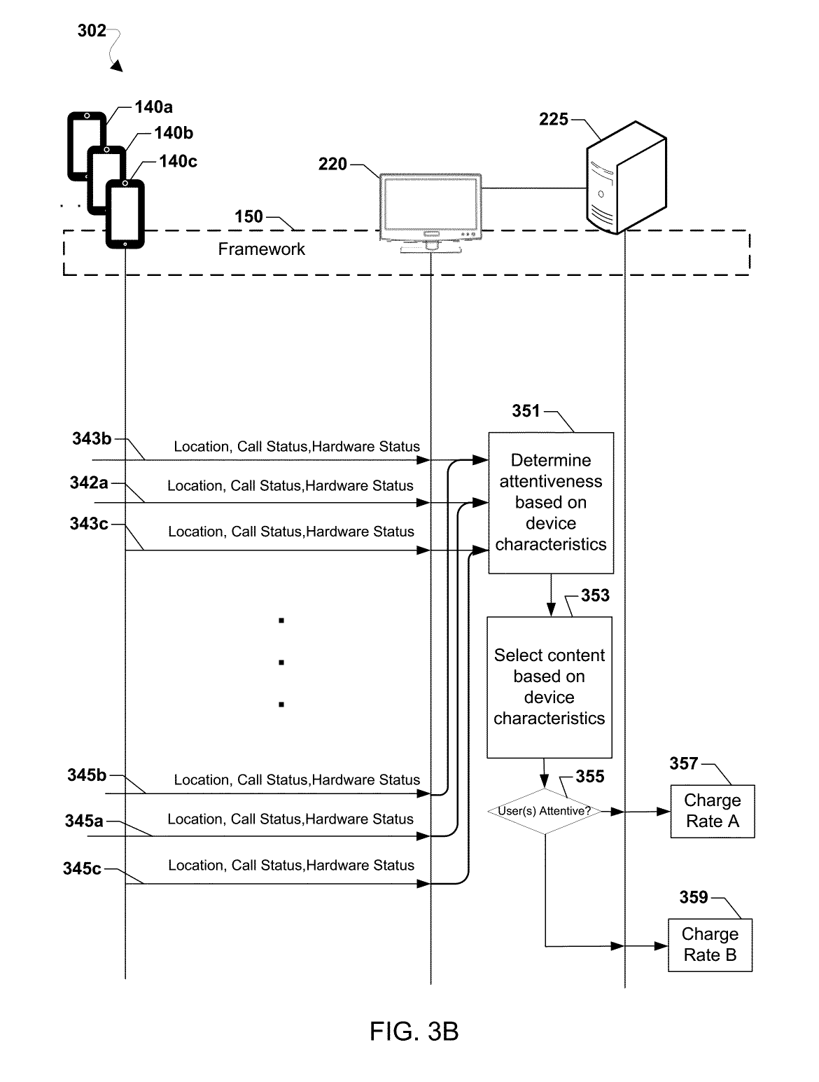

In the various embodiments, the communication networking framework 150 may provide an API or suitable messaging mechanism for mobile devices, such as the advertising device 220, the server 225 and the computing mobile devices 140a-140c to perform discovery, obtain mobile device characteristic, and perform other functions to enable the determination of attentiveness, audience make-up, and other operations as illustrated in FIG. 3A. While three mobile devices are shown, more or fewer mobile devices may be present as mobile devices move into and out of proximity to the advertising device 220. For example, when mobile devices 140a-140c enter communication range of the advertising device 220, networking framework discovery messages 341a-341c may be sent to the advertising device 220, facilitated by the communication networking framework 150. The networking framework discovery messages 341a-341c may advertise the presence of the computing mobile devices 140a-140c to the advertising device 220 and may provide information about the mobile devices 140a-140c. The communication networking framework discovery messages 341a-341c may include information about the computing mobile devices 140a-140c, such as the type of mobile device, mobile device ID, mobile device operational status, mobile device software status, mobile device hardware status, mobile device capabilities, etc. The communication networking framework discovery messages 341a-341c may further contain location information associated with the respective mobile devices 140a-140c. Alternatively or additionally, the advertising device 220 may also make at least a preliminary determination of the range of the computing mobile devices 140a-140c based on the radio communication parameters associated with the messages (e.g., RSSI) and/or relative location from trilateration, triangulation, or other relative position calculations or information.

When the advertising device 220 receives the communication networking framework discovery messages 341a-341c, networking framework status query messages 321a-321c may be sent from the advertising device 220 to the mobile device 140a-140c. In some embodiments, the communication networking framework status query messages 321a-321c may specifically inquire whether the computing mobile devices 140a-140c are engaged in a voice or video call, are active or inactive, have headphones in use, are operating applications (e.g., text messaging, games, etc.), and so one. In the illustrated example the communication networking framework status query messages 321a-321c are sent as separate messages to the computing mobile devices 140a-140c. In other examples, a networking framework broadcast message (not shown) may be sent to alert any mobile devices to send status information to the advertising device 220.

The computing mobile devices 140a-140c may send networking framework response messages in response to the communication networking framework query messages 321a-321c. For example, the mobile device 140b may send a networking framework response message 343b containing location information, call status, hardware status, and/or other status or information for the mobile device 140b. The mobile device 140a may send a networking framework response message 343a containing location information, call status, hardware status, and/or other status or information for the mobile device 140a. The mobile device 140c may send a networking framework response message 343c containing location information, call status, hardware status, and/or other status or information for the mobile device 140c. When the communication networking framework response messages 343a-343c containing location information, call status, hardware status, and/or other status or information for the mobile devices 140a-140c are received by the advertising device 220, a processor of the advertising device 220 may determine likely attentiveness of the users of the mobile devices 140a-140c.

In addition to the communication networking framework response messages 343a-343c, the mobile devices 140a-140c may be configured to generate status or status update messages as spontaneous messages 345a-345b containing location information, call status, hardware status, and/or other status or information for the mobile devices 140a-140c. As with response messages 343a-343c, the advertising device 220 may receive the spontaneous messages 345a-345c, and a processor of the advertising device 220 may determine likely attentiveness of the users of the mobile devices 140a-140c. The spontaneous messages 345a-345c may be generated by respective ones of the mobile devices 140a-140c when the mobile device status changes. For example, if the mobile device 140a receives a video call, the spontaneous message 345a can inform the advertising device 220 that the user of the mobile device is on a video call leading to an inference that the likely audible and visual attentiveness to the ad content is relatively low. If the user of the mobile device 140b plugs in headphones, the mobile device 140b may generate the spontaneous message 345b that informs the advertising device 220 that the user is wearing headphones leading to an inference that at least the likely audible attentiveness of the user is relatively low.

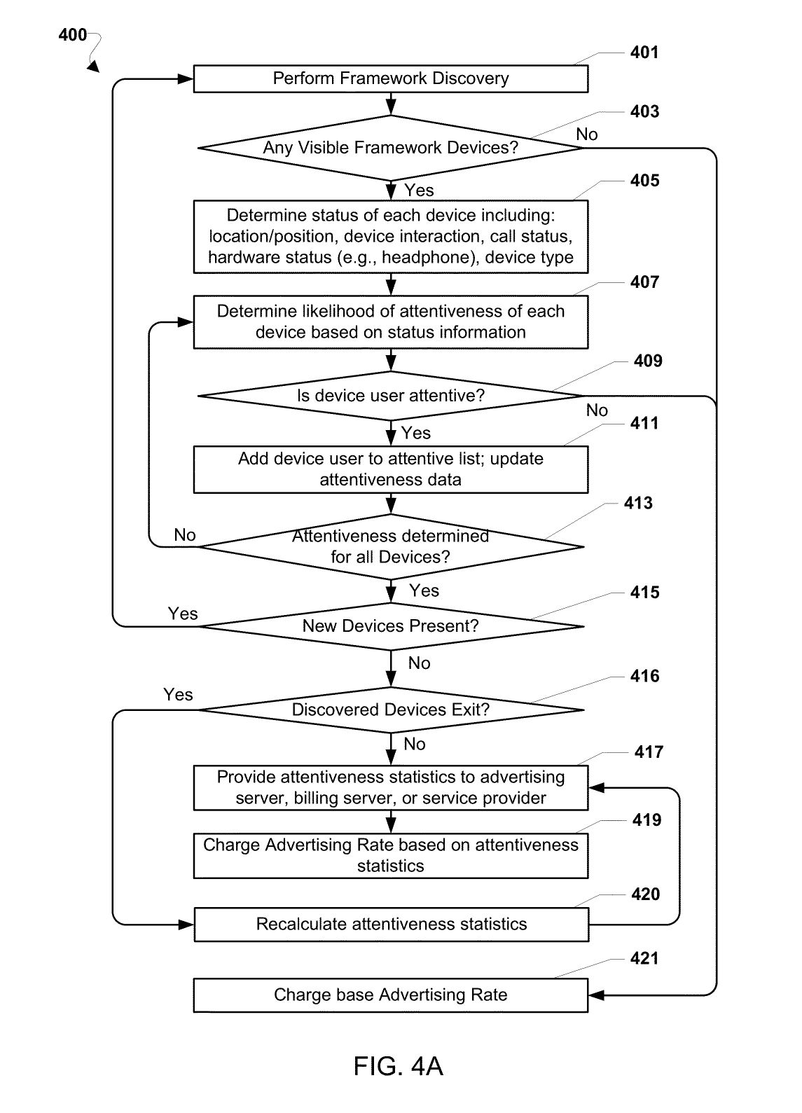

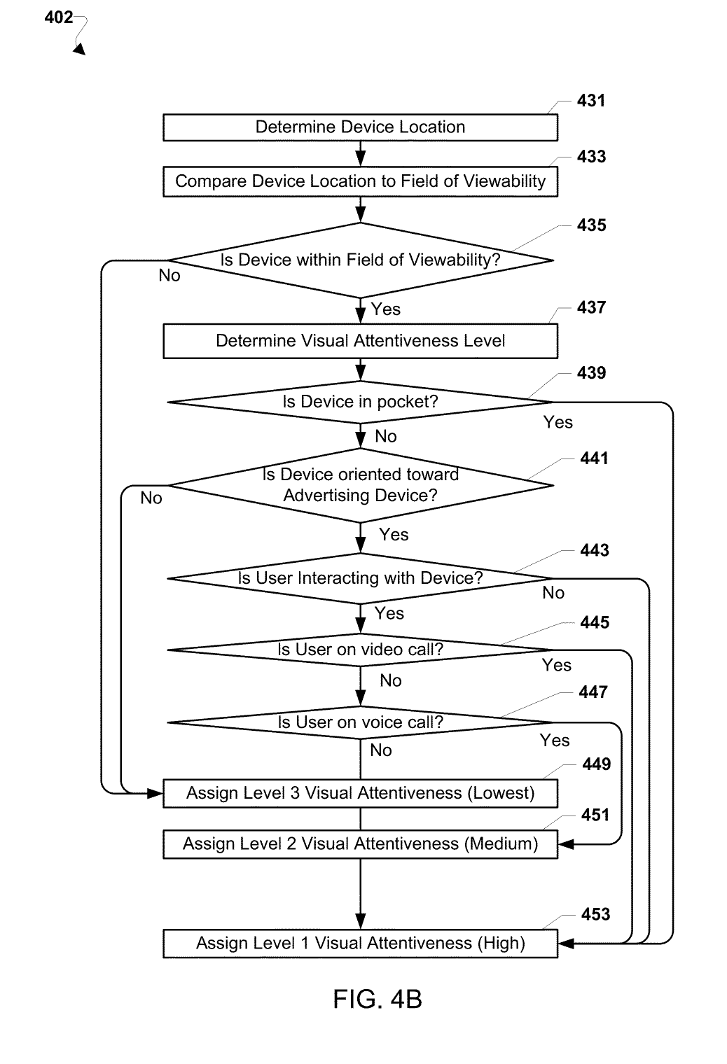

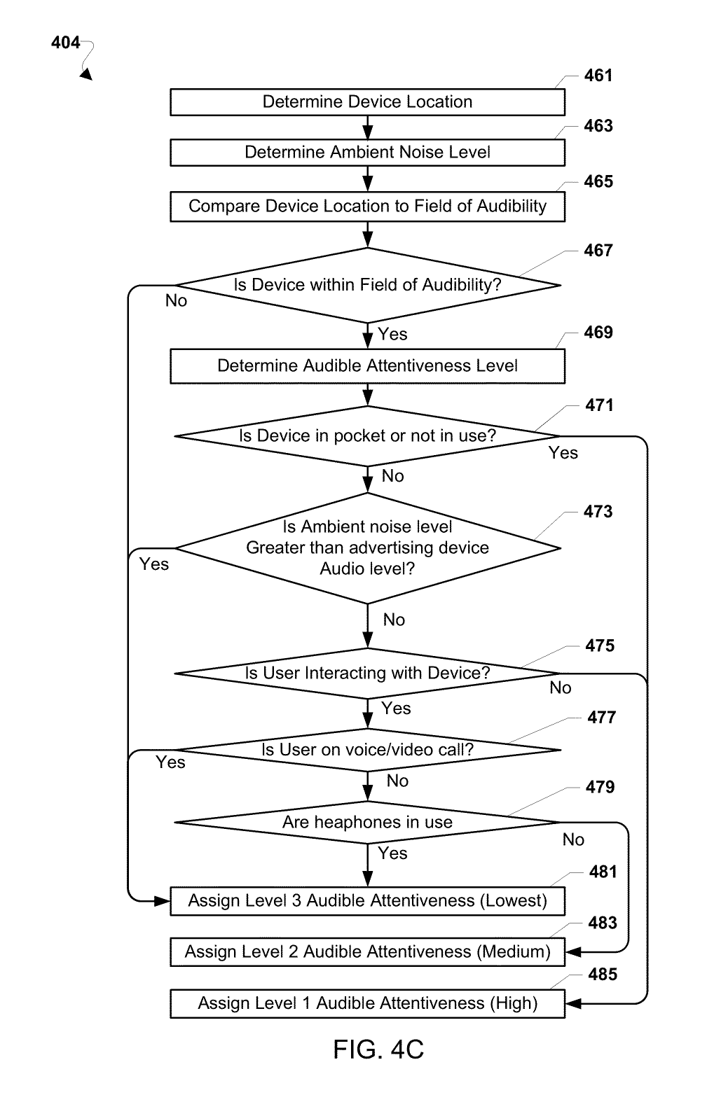

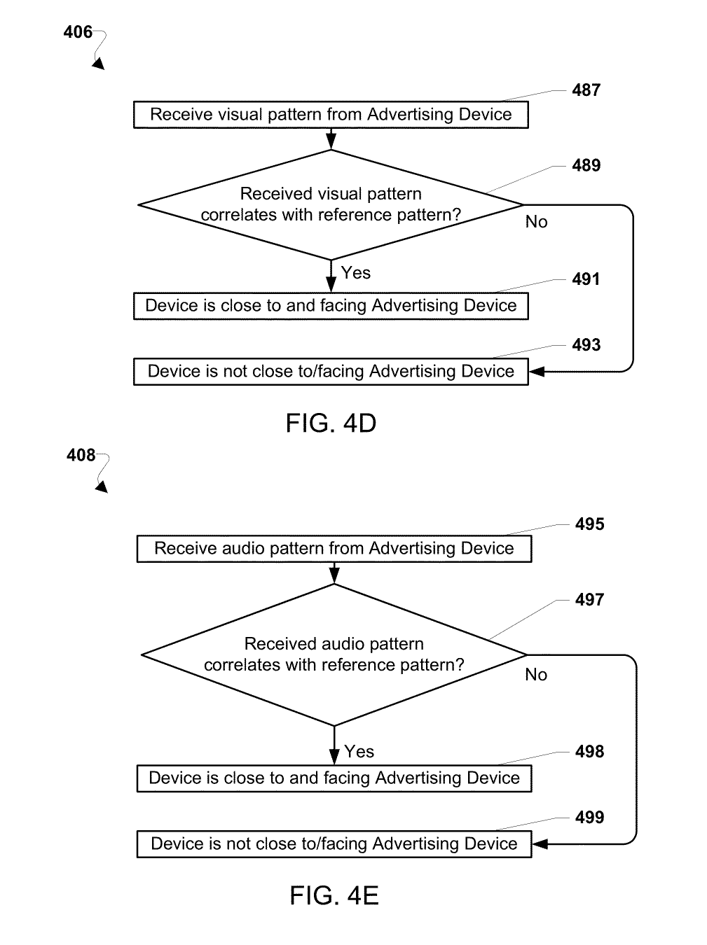

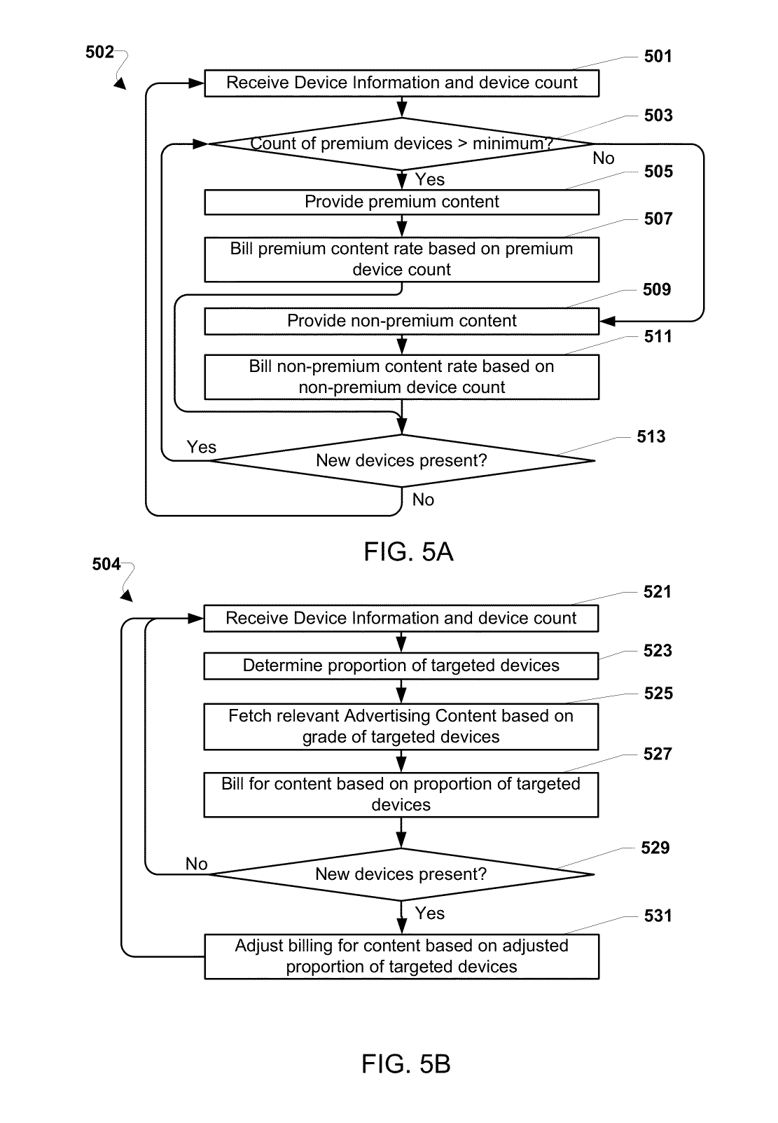

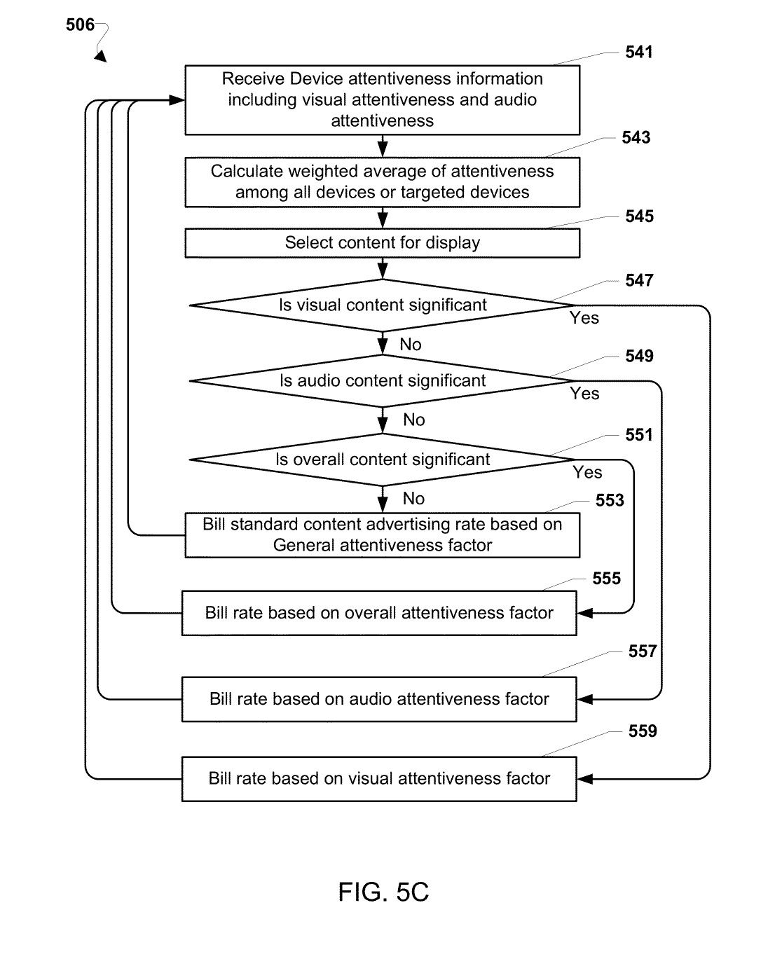

The attentiveness information may be used by a server 225 to determine an advertising rate for charging the advertiser that is providing the ad content. This server 225 may be a billing server, a framework server, an advertising server, or a combination thereof. In some embodiments, the information provided by the mobile devices 140a-140c, such as the mobile device type information, may be used to select ad content. For example, the mobile device type information (e.g., premium, non-premium, etc.) may be indicative of the socio-economic status of the user of the mobile device and may lead to the selection of appropriate ad content. In other embodiments, a particular type of phone may be known to be associated with a particular group or niche of consumers (e.g., users of phone type “X” are known to purchase performance automobiles of a particular brand), which may lead to the selection of particular ad content targeted to the group, such as if a certain number of phones of type “X” are detected. Embodiment methods for determining likely attentiveness and other mobile device characteristics and providing billing and content based on the characteristics are described in greater detail herein below in connection with FIG. 4A through FIG. 5C.

As illustrated in FIG. 3B, the mobile devices 140a-140c may generate the response messages 343a-343c, or spontaneous messages 345a-345c containing mobile device characteristic information or mobile device characteristic information updates. In block 351, a processor, such as a processor of the advertising device 220, the server 225, or other processor may determine the attentiveness of each of the mobile devices 140a-140c, as described previously herein, based on at least the mobile device characteristic information contained in the response messages 343a-343c and/or the spontaneous messages 345a-345c. In addition, the processor may apply averaging, weighting, aggregating, or other algorithms to provide an overall attentiveness of the audience 165. Alternatively or additionally, the processor may provide attentiveness information by groups of mobile devices. For example, if a particular demographic is determined to be associated with a particular phone type, the attentiveness of the users of the group of mobile devices determined to be using the particular phone type may be assessed separately, or may be given a higher attentiveness weighting.

In block 353, the processor may select ad content based on at least the mobile device characteristic information contained in the response messages 343a-343c and/or the spontaneous messages 345a-345c. For example, the processor may perform certain operations to determine the types of mobile devices in the audience 165. In some embodiments, if a particular group of mobile devices are determined to represent a sufficient number of premium mobile devices, premium ad content may be selected. In some embodiments, the processor may select different content for presentation at different times that attempts to provide content of interest to the users of all mobile devices in the audience 165. In the various embodiments, the likely attentiveness of users of mobile devices of a particular group may be determined and advertising rates and charges applied for ad content specifically selected for that group.

In determination block 355, the processor may determine the likely attentiveness of users of the mobile devices 140a-140c, individually or by groups of mobile devices, such as described in block 351. In response to determining that the users are likely to be attentive (i.e., determination block 355=“Yes”), the processor may charge an advertising rate A (e.g., an increased advertising rate) to the advertiser for displaying the ad content in block 357. In response to determining that the users are not likely to be attentive or are inattentive (i.e., determination block 355=“No”), the processor may charge an advertising rate B in block 359, such as a decreased rate, to the advertiser for displaying the ad content.

Embodiment methods for determining mobile device characteristics and providing advertising rates based on the determined mobile device characteristics is illustrated in FIG. 4A-4C. In FIG. 4A, an embodiment method 400 may include various operations for determining mobile device characteristics, likely user attentiveness, and providing advertising rates for advertising based on the determined characteristics and attentiveness.

In block 401, a processor or processors, such as may be associated with one or more mobile device, advertising devices, and/or servers (e.g., billing, advertising, framework, etc.) may perform networking framework discovery. As described previously herein, networking framework discovery may include the transmission and reception by the processor or processors of networking framework discovery messages. In some embodiments, such as in embodiments using an AllJoyn framework, at least some of the discovery messages or discovery-related messages may include AllJoyn “About” messages that provide detailed information for each mobile device. For example, the About message or announcement from a mobile device may include detailed metadata for the mobile device and a list of interfaces that may be accessed.

In determination block 403, the processor of an advertising device may determine whether any networking framework compatible mobile devices are present. In response to determining that networking framework compatible mobile devices are not present (i.e., determination block 403=“No”), the processor may charge a base advertising rate in block 421. For example, in some embodiments the processor may communicate the number of framework compatible mobile devices to a server, such as an advertising server or billing server. In other embodiments, the advertising device may be coupled to a framework server, which may facilitate charging the advertising rate by communicating the number of framework compatible mobile devices to a billing or advertising server. In still other embodiments, the framework compatible mobile devices may communicate directly with the framework server. In some embodiments, the processor may determine that an insufficient number of framework compatible mobile devices are present to justify adjustments to the advertising rates. In response to determining that networking framework compatible mobile devices are present (i.e., determination block 403=“Yes”), the processor may determine mobile device characteristics, such as the status of each mobile device including information such as the location or position of the mobile device, mobile device user interaction information, call status information, hardware status information, mobile device type information, and possibly other information in block 405. The information may include the discovery information received or obtained in block 401.

In block 407, the processor may determine the likelihood of attentiveness of the users of the mobile devices based on the mobile device characteristic information from block 405. For example, one or more elements of the mobile device characteristic information may indicate that the user of the mobile device is attentive or inattentive. In some embodiments, the mobile device characteristic information may indicate a level of attentiveness.

In determination block 409, the processor may determine whether the user of the mobile device is attentive or likely to be attentive, such as based on the mobile device characteristic information. In response to determining that the mobile device user is not attentive or not likely to be attentive (i.e., determination block 409=“No”), the processor may charge a base advertising rate in block 421. For example, in some embodiments the processor may communicate the attentiveness information to a server, such as an advertising server or billing server. In other embodiments, the advertising device may be coupled to a framework server, which may facilitate charging the advertising rate by communicating the attentiveness information for the mobile device to a billing or advertising server. In still other embodiments, the framework compatible mobile devices may communicate directly with the framework server. In response to determining that the mobile device user is attentive or likely to be attentive (i.e., determination block 409=“Yes”), the processor may add the mobile device to a list of mobile devices for which users are likely to be attentive, or otherwise update attentiveness data in block 411. For example, in order to calculate average attentiveness data for an entire audience, the processor may collect attentiveness information for each mobile device and then perform average calculations, including weightings or other algorithms to determine an overall attentiveness for an audience or a group within the audience. The processor may wait until attentiveness for all discovered mobile devices has been determined because calculating attentiveness for the audience. Alternatively or additionally, the processor may periodically calculate attentiveness for the audience as new mobile devices enter or leave the framework. In some embodiments, the processor may perform attentiveness calculations for the audience before, during, and/or after a particular advertisement is being presented.

In determination block 413, the processor may determine whether attentiveness has been determined for all mobile devices in the audience. In response to determining that attentiveness for all mobile devices has not been determined (i.e., determination block 413=“No”), the processor may return to block 407 to determine attentiveness for additional mobile devices in the audience. In response to determining that attentiveness for all mobile devices has been determined (i.e., determination block 413=“Yes”), the processor may proceed to determination block 415.

In determination block 415, the processor may determine whether new mobile devices are present. In response to determining that new mobile devices are present (i.e., determination block 415=“Yes”), the processor may perform framework discovery of new mobile devices in block 401. In some embodiments, new mobile devices joining the framework may immediately announce their presence by sending a framework discovery message to the processor and the processor may not be required to make a specific determination. In response to determining that new mobile devices are not present (i.e., determination block 415=“Yes”), the processor may proceed to determination block 416.

In determination block 416, the processor may determine whether mobile devices that were previously discovered have exited the framework. In response to determining that discovered mobile devices have exited the framework (i.e., determination block 416=“Yes”) the processor may recalculate or update attentiveness statistics in block 420. For example, attentiveness information based on mobile device characteristic information for the mobile device that has exited the framework may be deleted from the list or data generated in block 411. In response to determining that discovered mobile devices have not exited the framework (i.e., determination block 416=“No”) the processor may provide the attentiveness statistics to a server, such as a framework server, a billing server or advertising server, which may be associated with or in communication with a service provider for billing services in block 417. The server may also be associated with or in communication with a server or service that provides ad content. In block 419, the processor of the server may charge an advertising rate based on the attentiveness statistics.

An embodiment method 402, as illustrated in FIG. 4B, may include operations for determining a likely visual attentiveness level of a user of a mobile device. In block 431, the processor, such as the processor of the advertising device, or other mobile device or mobile devices, may determine a location of the mobile device. For example, using the mobile device characteristics, such as those received during discovery, the processor may determine a location or position of the mobile device (e.g., GNSS, GPS, etc.). Alternatively or additionally, the mobile device location may be determined or refined using position information developed through trilateration, triangulation, or other mechanism. The location information may be facilitated by relative position information developed during P2P or D2D communication between framework mobile devices.

In block 433, the processor may compare the determined mobile device location with a field of viewability of the advertising device. For example, the processor may be configured to know the field of viewability of the advertising device. In some embodiments, the field of view may be within a certain degree of precision. For example, the processor may know the field of viewability based on the display size, the brightness levels, and other factors. The field of viewability may be a series of coordinates defining a boundary. Alternatively or additionally, the field of viewability may be a series of approximate measures of distance and angle from a reference point, such as a reference line extending in a perpendicular direction from the center of the planar surface of the display of the advertising device. In other embodiments the field of viewability may be a front/back reference, whereby the processor may determine that mobile devices in front of the advertising device (e.g., on one side of a plane oriented with and including the display screen) are within the field of viewability and mobile devices behind the advertising device (e.g., on the other side of the plane) are not within the field of viewability. Other mechanisms are possible for determining the field of viewability depending on a desired degree of precision.

In determination block 435, the processor may determine whether the mobile device is within the field of viewability, such as based on the comparison in block 433. In response to determining that the mobile device is not within the field of viewability (i.e., determination block 435=“No”), the processor may assign a lowest level of likely visual attentiveness for the user of the mobile device in block 449. In response to determining that the mobile device is within the field of viewability (i.e., determination block 435=“Yes”), the processor may determine a likely visual attentiveness level for the user of the mobile device in block 437.

In determination block 439, the processor may determine whether the mobile device is in or likely to be in a pocket of the user. For example, the mobile device characteristics may include information indicating that the mobile device is inactive, e.g. turned off (e.g., while maintaining a connection to the framework). In some embodiments, the mobile device may be configured with a pocket detection algorithm. The pocket detection algorithm may detect the placement of the mobile device in the pocket of a user based on information such as camera input, location input, gesture input or other input. The pocket detection information may be provided to the processor with mobile device characteristic information for the mobile device. In other embodiments, the mobile device characteristic data received by the processor from the mobile device may allow the processor to infer that the mobile device is in the user's pocket. In response to determining that the mobile device is in a pocket of the user (i.e., determination block 439=“Yes”), the processor may assign a highest level of likely visual attentiveness (e.g., Level 1) for the user of the mobile device in block 453. In response to determining that the mobile device is not in a pocket of the user (i.e., determination block 439=“No”), the processor may proceed to determination block 441.

In determination block 441, the processor may determine whether the mobile device is oriented toward the advertising device. For example, using various mobile device-based systems, such as a mobile device camera system, a mobile device accelerometer system, a mobile device compass system, the processor may determine the orientation of the mobile device relative to the position of the mobile device and the position of the display of the advertising device. In some embodiment, one determination may indicate that the mobile device is “in front” of the advertising device, while a subsequent determination, such as the orientation determination may indicate that the mobile device is not facing the advertising device (see, e.g., FIG. 2E). Thus, the determination of attentiveness for one characteristic may be subject to further attentiveness determinations. For example, while “in front” of the advertising device leading to one attentiveness determination, the mobile device may oriented away from the advertising device (e.g., has back toward mobile device), leading to a second attentiveness determination, or a modification of the overall attentiveness determination. In response to determining that the mobile device is not oriented toward the advertising device (i.e., determination block 441=“No”), the processor may assign a lowest level of likely visual attentiveness (e.g., Level 3) for the user of the mobile device in block 449. In response to determining that the mobile device is oriented toward the advertising device (i.e., determination block 441=“No”), the processor may proceed to determination block 443.

In determination block 443, the processor may determine whether a user is interacting with the mobile device. For example, the processor may receive mobile device characteristics indicating that an application is active, such as the processor is receiving keyboard inputs, accelerometer data indicates that the mobile device is moving consistent with user interactions, a camera image of the user's face indicating that the user's eyes are focused on the display, or other indications of user interactions with the mobile device by the user. In response to determining that the user is not interacting with the mobile device (i.e., determination block 443=“No”), the processor may assign a highest level of likely visual attentiveness (e.g., Level 1) for the user of the mobile device in block 453. In response to determining that the user is interacting with the mobile device (i.e., determination block 443=“Yes”), the processor may proceed to determination block 445.

In determination block 445, the processor may determine whether a user is interacting with the mobile device on a video call. For example, the processor may receive mobile device characteristics indicating that the mobile device, and thus presumably the user, is engaged in a video call. In response to determining that the user on a video call (i.e., determination block 447=“Yes”), the processor may assign a low level of likely visual attentiveness (e.g., Level 3) for the user of the mobile device in block 451. For example, if the user is engaged in a video call, the user may unlikely to be visually attentive to the advertising device. In response to determining that the user is not on a video call (i.e., determination block 443=“No”), the processor may proceed to determination block 447.

In determination block 447, the processor may determine whether a user is interacting with the mobile device on a voice call. For example, the processor may receive mobile device characteristics indicating that the mobile device, and thus presumably the user, is engaged in a voice call. In response to determining that the user on a voice call (i.e., determination block 447=“Yes”), the processor may assign a medium level of likely visual attentiveness (e.g., Level 2) for the user of the mobile device in block 451. For example, if the user is engaged in a voice call, the user may nevertheless be at least able to be visually attentive to the advertising device. In response to determining that the user is not on a voice call (i.e., determination block 447=“No”), the processor may assign a highest level of likely visual attentiveness (e.g., Level 1) for the user of the mobile device in block 451. For example, while the user may be interacting with the mobile device, the interactions may be insufficient to impact the visual attentiveness of the user to the advertising device.

An embodiment method 404, as illustrated in FIG. 4C, may include operations for determining a likely audible attentiveness level of a user of a mobile device. In block 461, the processor, such as the processor of the advertising device, or other mobile device or mobile devices, may determine mobile device location in a manner similar as in block 431 of FIG. 4B, which may be relevant to a field of audibility.

In block 463, the processor may determine an ambient noise level of the venue where the audience is present. For example, the advertising device may be configured with a microphone that can provide a measurement of the ambient noise level to the processor. The ambient noise level may be the level of noise in the venue without the contribution of audio from the advertising device. Alternatively or additionally, the processor may receive ambient noise measurements from external microphones or audio sensors to which it may be coupled through the framework. The ambient noise measurements may be conducted continuously or periodically. The ambient noise measurements may be more sophisticated and may include acoustic characterizations of the venue to provide an enhanced audible attentiveness determination capability.

In block 465, the processor may compare the determined mobile device location with a field of audibility of the advertising device. For example, the processor may be configured to know the field of audibility of the advertising device. In some embodiments, the field of audibility may be determined within a certain degree of precision. For example, the processor may know the field of audibility based on the volume, frequency, and other acoustic factors. The field of audibility may be a series of coordinates defining a boundary. Alternatively or additionally, the field of audibility may be a series of approximate measures of distance and angle from a reference point, such as a reference line extending in a perpendicular direction from the center of a speaker or speakers of the advertising device. In other embodiments the field of audibility may be a front/back reference, whereby the processor may determine that mobile devices in front of the advertising device (e.g., on one side of a plane oriented with and including the speakers) are within the field of audibility and mobile devices behind the advertising device (e.g., on the other side of the plane) are not within the field of audibility. However, in some embodiments, unlike the field of viewability, the field of audibility may extend somewhat behind the advertising device. Other mechanisms are possible for determining the field of audibility depending on a desired degree of precision.

In determination block 467, the processor may determine whether the mobile device is within the field of audibility, such as based on the comparison in block 465. In response to determining that the mobile device is not within the field of audibility (i.e., determination block 467=“No”), the processor may assign a lowest level (e.g., Level 3) of likely audible attentiveness for the user of the mobile device in block 481. In response to determining that the mobile device is within the field of audibility (i.e., determination block 467=“Yes”), the processor may determine a likely audible attentiveness level for the user of the mobile device in block 469, such as through a series of determinations.

In determination block 471, the processor may determine whether the mobile device is in or likely to be in a pocket of the user. For example, the mobile device characteristics may include information indicating that the mobile device is inactive, e.g. turned off (e.g., while maintaining a connection to the framework). In some embodiments, the mobile device may be configured with a pocket detection algorithm. The pocket detection algorithm may detect the placement of the mobile device in the pocket of a user based on information such as camera input, location input, gesture input or other input. The pocket detection information may be provided to the processor with mobile device characteristic information for the mobile device. In other embodiments, the mobile device characteristic data received by the processor from the mobile device may allow the processor to infer that the mobile device is in the user's pocket. In response to determining that the mobile device is in a pocket of the user (i.e., determination block 471=“Yes”), the processor may assign a highest level of likely visual attentiveness (e.g., Level 1) for the user of the mobile device in block 485. In response to determining that the mobile device is not in a pocket of the user (i.e., determination block 471=“No”), the processor may proceed to determination block 473.

In determination block 473, the processor may determine whether the ambient noise level determined in block 463 is greater than the audio output level of the advertising device. For example, the processor may know the audio output level of the advertising device and may be able to compare the known level to a measured level of ambient noise. In other embodiments, the processor may be configured to measure both the ambient noise and the audio output from the advertising device in order to determine a factor, such as an acoustic signal to noise ratio of the audio output of the advertising device. In response to determining that the ambient noise level is greater than the audio output of the advertising device (i.e., determination block 473=“Yes”), the processor may assign a lowest level of likely audible attentiveness (e.g., Level 3) for the user of the mobile device in block 481. In response to determining that the ambient noise level is not greater than the audio output of the advertising device (i.e., determination block 473=“No”), the processor may proceed to determination block 475.

In determination block 475, the processor may determine whether the user is interacting with the mobile device. For example, the processor may receive mobile device characteristics indicating that an application is active, such as the processor is receiving keyboard inputs, accelerometer data indicates that the mobile device is moving consistent with user interactions, a camera image of the user's face indicating that the user's eyes are focused on the display, or other indications of user interactions with the mobile device by the user. In response to determining that the user is not interacting with the mobile device (i.e., determination block 475=“No”), the processor may assign a highest level of likely audible attentiveness (e.g., Level 1) for the user of the mobile device in block 485. In response to determining that the user is interacting with the mobile device (i.e., determination block 475=“Yes”), the processor may proceed to determination block 477.

In determination block 477, the processor may determine whether a user is interacting with the mobile device on a voice or video call. For example, the processor may receive mobile device characteristics indicating that the mobile device, and thus presumably the user, is engaged in a voice or video call. In response to determining that the user on a voice or video call (i.e., determination block 477=“Yes”), the processor may assign a lowest level of likely audible attentiveness (e.g., Level 1) for the user of the mobile device in block 451. For example, if the user is engaged in a voice or video call, the user may be unlikely to be audibly attentive to the advertising device. In response to determining that the user is not on a voice or video call (i.e., determination block 477=“No”), the processor proceed to determination block 479.

In determination block 479, the processor may determine whether headphones are currently in use with the mobile device. While headphones may be in use with a voice or video call as determined in determination block 477, headphones may be in use aside from a voice or video call, such as to listen to music or interact with other mobile device applications. In response to determining that headphones are not in use (i.e., determination block 479=“No”), the processor may assign a medium level of likely audible attentiveness (e.g., Level 2) for the user of the mobile device in block 483, as interactions with the mobile device have previously been determined (e.g., determination block 475=“Yes”). In response to determining that headphones are in use (i.e., determination block 479=“Yes”), the processor may assign a lowest level of likely audible attentiveness (e.g., Level 3) for the user of the mobile device in block 481.

Refinements to visual and audio attentiveness determinations may be facilitated in embodiment methods 406 and 408 as illustrated in FIG. 4D and FIG. 4E. In embodiment method 406, a mobile device processor, may receive a visual pattern, which has been embedded in the visual content of the advertising from the advertising device (see, e.g., FIG. 2E) in block 487. For example, the camera of the mobile device may pick up the visual pattern, such as a flicker pattern in the visual output of the advertising device. In determination block 489, the processor may determine whether the received visual pattern correlates with the reference pattern, which is the pattern known to be embedded in the output of the advertising device. As described in connection with FIG. 2E, the correlation may be a degree or percentage of correlation between the received pattern and the reference pattern that exceeds a threshold correlation degree or percentage (e.g., 80%). In response to determining that the received pattern is not correlated with the reference pattern (i.e., determination block 489=“No”), the processor may determine that the mobile device is not close to or facing the advertising device in block 493. In response to determining that the received pattern is correlated with the reference pattern (i.e., determination block 489=“Yes”), the processor may determine that the mobile device is close to or facing the advertising device in block 491.

In embodiment method 408, a mobile device processor, may receive an audio pattern, which has been embedded in the audio content of the advertising from the advertising device (see, e.g., FIG. 2E) in block 495. For example, the microphone of the mobile device may pick up the audio pattern, such as a modulation pattern of the audio output of the advertising device. In determination block 497, the processor may determine whether the received audio pattern correlates with the reference pattern, which is the pattern known to be embedded in the audio output of the advertising device. As described in connection with FIG. 2E, the correlation may be a degree or percentage of correlation between the received pattern and the reference pattern that exceeds a threshold correlation degree or percentage (e.g., 80%). In response to determining that the received pattern is not correlated with the reference pattern (i.e., determination block 497=“No”), the processor may determine that the mobile device is not close to or facing the advertising device in block 498. In response to determining that the received pattern is correlated with the reference pattern (i.e., determination block 497=“Yes”), the processor may determine that the mobile device is close to or facing the advertising device in block 499.

In the various embodiments, the correlation may be conducted in the mobile device processor and a correlation results forwarded in the mobile device characteristics to the advertising device, the server or other mobile device. In other embodiments, the received pattern data may be forwarded in the mobile device characteristics to the advertising device, the server, or other mobile device and the correlation calculations may be performed by the receiving mobile device.

In the various embodiments, attentiveness information and other mobile device characteristic information may be used to select and/or determine the advertising rate for the ad content displayed on the advertising device. Various embodiment methods are illustrated in FIG. 5A, FIG. 5B, and FIG. 5C for performing such operations. In block 501 of FIG. 5A, a processor of a server, such as an advertising server, billing server, and/or framework server may receive mobile device characteristic information from mobile devices in an audience including mobile device type, mobile device count, etc.

In determination block 503, the processor may determine whether the number of premium mobile devices is greater than a minimum number of premium mobile devices established by the advertiser. For example, in order to justify the cost of providing premium content an advertiser may require a minimum of ten (10) premium mobile devices in an audience. The minimum may be more or fewer than ten based on the advertising rates. In some embodiments, the number of premium mobile devices may include mobile devices that have already been determined to be attentive. In other embodiments, attentiveness determinations may be made at a later time and may affect the advertising rate charged to the advertiser. In response to determining that the number of premium mobile devices is not greater than a minimum (i.e., determination block 503=“No”), the processor may provide non-premium content in block 509. In response to determining that the number of premium mobile devices is greater than a minimum (i.e., determination block 503=“Yes”), the processor may provide premium content in block 505.

In block 507, the processor may bill a premium content rate based on the number of premium mobile devices in the audience. Alternatively or additionally, a given rate may be charged for any display of the premium content such that the minimum number of premium mobile devices is that which justifies the given premium rate. The premium rate may later be modified based on attentiveness determinations as discussed herein.

In block 511, in the event non-premium content is provided (e.g., in block 509) the processor may bill a non-premium content rate based on the number of non-premium mobile devices in the audience. Alternatively or additionally, a minimum number of non-premium mobile devices or any mobile devices may justify a non-premium advertising rate that may be charged for the display of non-premium ad content. The non-premium rate may later be modified based on attentiveness determinations as discussed herein.

In determination block 513, the processor may determine whether new mobile devices are present. In response to determining that new mobile devices are present (i.e., determination block 513=“Yes”), the processor may re-evaluate the count of premium mobile devices in determination block 503. In response to determining that new mobile devices are not present (i.e., determination block 513=“No”) the processor may await a notification the arrival of new mobile devices or that mobile devices have exited the framework in block 501.

In embodiment method 504, as illustrated in FIG. 5B, content may be selected and billed based on target grade of mobile devices. In block 521, the processor of a server, such as an advertising server, billing server, framework server, or other server, may receive mobile device information, such as mobile device characteristics including mobile device type or grade, mobile device count and possibly other information. In some embodiments, particular ones of the mobile devices may be targeted for ad content. For example, premium mobile devices may be targeted for premium ad content. In more specific examples, particular types of mobile devices may be indicative of specialized interests for their users, as previously described. For example, users of phones of a type “X” may, as a group, have a known interest in a particular high performance automobile. Thus, advertising for the particular automobile may be targeted to those users/mobile devices.

In block 523, the processor may determine a proportion of the targeted mobile devices (e.g., mobile devices of a target grade) in the audience. In block 535, the process may fetch the relevant ad content based on the target grade of mobile devices. In block 537, the processor may bill the advertiser an advertising rate based on the proportion of target grade mobile devices in the audience.

In determination block 529, the processor may determine whether new mobile devices are present. In response to determining that new mobile devices are present (i.e., determination block 529=“Yes”), the processor may adjust the advertising rate charged to the advertiser based on the new proportion of targeted mobile devices in block 531. In response to determining that new mobile devices are not present (i.e., determination block 529=“No”), the processor may await notification of additional mobile device characteristic information in block 521.

A further embodiment method 506 for performing billing operations based on likely attentiveness of users is illustrated in FIG. 5C. In block 541, a processor of a server, such as an advertising server, a billing server, a framework server or other server may receive attentiveness information including visual attentiveness and audio attentiveness information. In some embodiments, the server may be registered with the framework and the processor of the server may receive the attentiveness information directly from mobile devices. In other embodiments, the processor may receive the attentiveness information from the advertising device or other server that is registered with the framework.

In block 543, the processor may calculate a weighted average of attentiveness among all the mobile devices or among a portion of the mobile devices, such as the targeted mobile devices. In some embodiments, the processor may calculate separate averages for visual attentiveness and for audio attentiveness.

In block 545, the processor may select ad content based on the attentiveness information. The selected advertising may include targeted advertising based on the attentiveness of the target group. In other embodiments, ad content may be pre-selected and attentiveness information may be used to modify the advertising rate charged to the advertiser for the content.

In determination block 547, the processor may determine whether the visual content for the selected advertising is significant. In response to determining that the visual content is significant (i.e., determination block 547=“Yes”), the processor may bill an advertising rate to the advertiser based on the visual attentiveness in block 559. In response to determining that the visual content is not significant (i.e., determination block 547=“No”), the processor may proceed to determination block 549.

In determination block 549, the processor may determine whether the audio content for the selected advertising is significant. In response to determining that the audio content is significant (i.e., determination block 549=“Yes”), the processor may bill an advertising rate to the advertiser based on the audio attentiveness in block 557. In response to determining that the visual content is not significant (i.e., determination block 549=“No”), the processor may proceed to determination block 551.

In determination block 551, the processor may determine whether the overall content (e.g., combined visual and audio content) for the selected advertising is significant. In response to determining that the overall content is significant (i.e., determination block 551=“Yes”), the processor may bill an advertising rate to the advertiser based on the overall attentiveness in block 555. In response to determining that the overall content is not significant (i.e., determination block 551=“No”), the processor may bill a standard content rate based on general attentiveness.

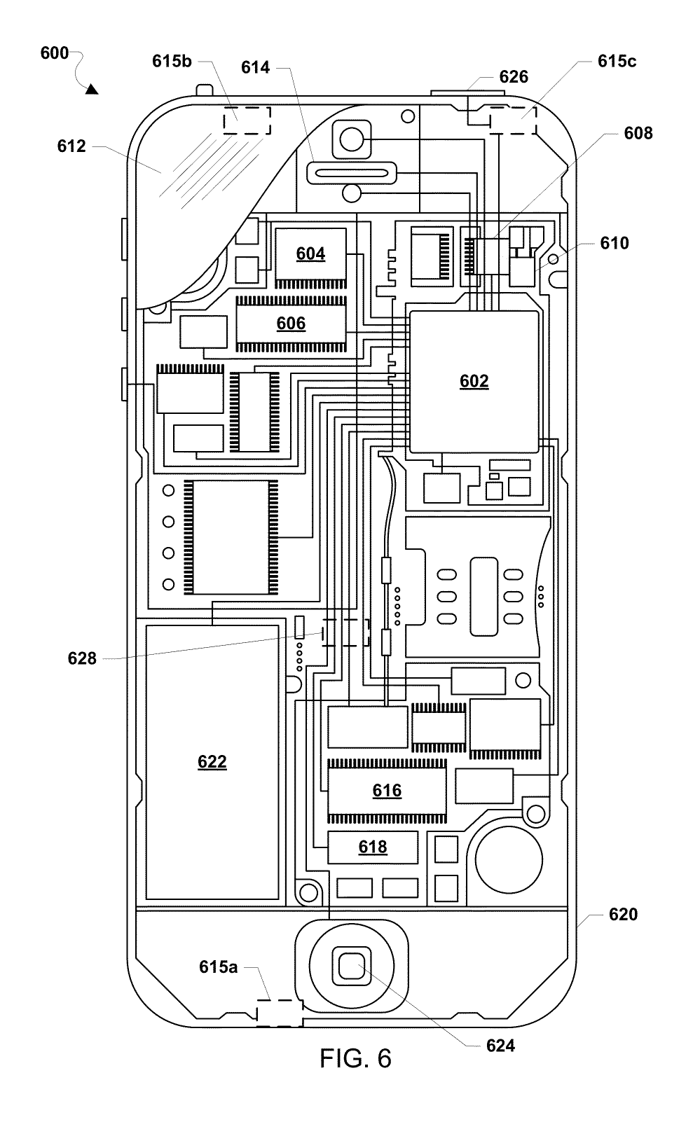

The various aspects, including the embodiment methods for determining attentiveness and performing billing and other operations as described in connection with FIGS. 2E, 3A-3B, 4A-4E, and 5A-5B, may be implemented in any of a variety of mobile devices (e.g., smartphones, tablets, etc.) an example of which is illustrated in FIG. 6. The mobile device 600 may include a processor 602 coupled the various systems of the computing mobile device 600 for communication with and control thereof. For example, the processor 602 may be coupled to a touch screen controller 604, radio communication elements, speakers and microphones, and an internal memory 606. The processor 602 may be one or more multi-core integrated circuits designated for general or specific processing tasks. The internal memory 606 may be volatile or non-volatile memory, and may also be secure and/or encrypted memory, or unsecure and/or unencrypted memory, or any combination thereof. In another embodiment (not shown), the computing mobile device 600 may also be coupled to an external memory, such as an external hard drive.

The touch screen controller 604 and the processor 602 may also be coupled to a touch screen panel 612, such as a resistive-sensing touch screen, capacitive-sensing touch screen, infrared sensing touch screen, etc. Additionally, the display of the mobile device 600 need not have touch screen capability. The mobile device 600 may have one or more radio signal transceivers 608 (e.g., Peanut, Bluetooth, Bluetooth LE, Zigbee, Wi-Fi, RF radio, etc.) and antennae 610, for sending and receiving communications, coupled to each other and/or to the processor 602. The transceivers 608 and antennae 610 may be used with the above-mentioned circuitry to implement the various wireless transmission protocol stacks and interfaces. The mobile device 600 may include a cellular network wireless modem chip 616 that enables communication via a cellular network and is coupled to the processor.

The mobile device 600 may include a peripheral mobile device connection interface 618 coupled to the processor 602. The peripheral mobile device connection interface 618 may be singularly configured to accept one type of connection, or may be configured to accept various types of physical and communication connections, common or proprietary, such as USB, FireWire, Thunderbolt, or PCIe. The peripheral mobile device connection interface 618 may also be coupled to a similarly configured peripheral mobile device connection port (not shown).

In some embodiments, the mobile device 600 may include microphones 615. For example, the mobile device may have a conventional microphone 615a for receiving voice or other audio frequency energy from a user during a call. The mobile device 600 may further be configured with additional microphones 615b and 615c, which may be configured to receive audio including ultrasound signals. Alternatively, all microphones 615a, 615b, and 615c may be configured to receive ultrasound signals. The microphones 615 may be piezo-electric transducers, or other conventional microphone elements. Because more than one microphone 615 may be used, relative location information may be received in connection with a received ultrasound signal through various triangulation methods. At least two microphones 615 configured to receive ultrasound signals may be used to generate position information for an emitter of ultrasound energy.

The mobile device 600 may also include speakers 614 for providing audio outputs. The mobile device 600 may also include a housing 620, constructed of a plastic, metal, or a combination of materials, for containing all or some of the components discussed herein. The mobile device 600 may include a power source 622 coupled to the processor 602, such as a disposable or rechargeable battery. The rechargeable battery may also be coupled to the peripheral mobile device connection port to receive a charging current from a source external to the mobile device 600. The mobile device 600 may also include a physical button 624 for receiving user inputs. The mobile device 600 may also include a power button 626 for turning the mobile device 600 on and off.

In some embodiments, the mobile device 600 may further include an accelerometer 628, which senses movement, vibration, and other aspects of the mobile device through the ability to detect multi-directional values of and changes in acceleration. In the various embodiments, the accelerometer 628 may be used to determine the x, y, and z positions of the mobile device 600. Using the information from the accelerometer, a pointing direction of the mobile device 600 may be detected.

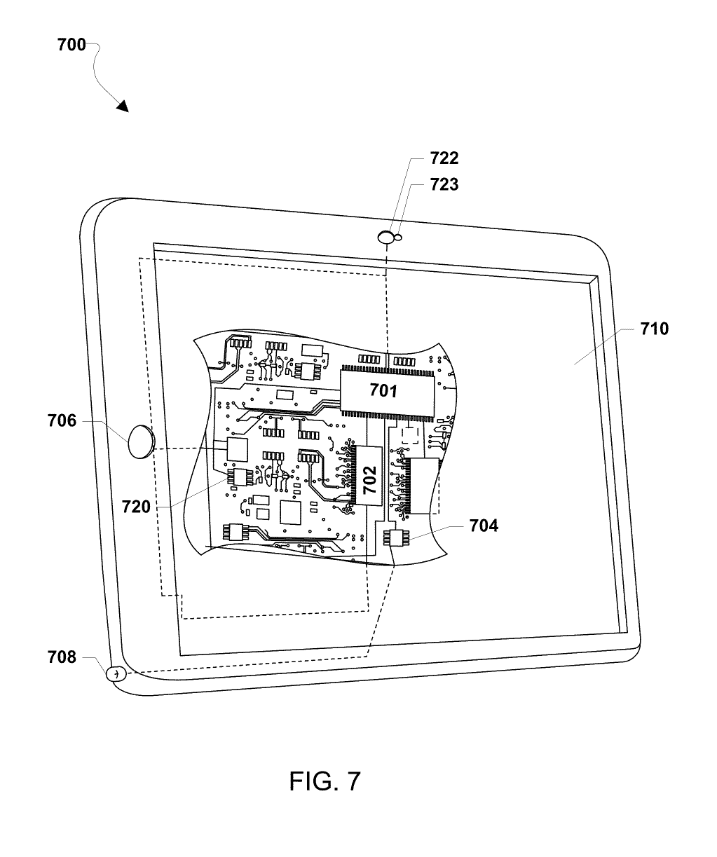

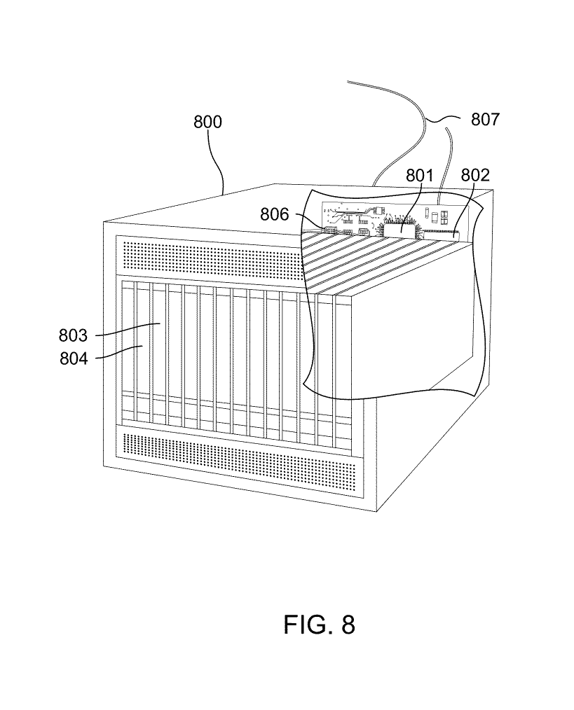

The various embodiments may be implemented in any of a variety of advertising devices, example of which in the form of a flat screen television is illustrated in FIG. 7. For example, a flat screen television 700 may include a processor 701 coupled to internal memory 702. The internal memory 702 may be volatile or non-volatile memory, and may also be secure and/or encrypted memory, or unsecure and/or unencrypted memory, or any combination thereof. The processor 701 may also be coupled to a touch screen display 710, such as a resistive-sensing touch screen, capacitive-sensing touch screen infrared sensing touch screen, etc. The flat screen television 700 may have one or more radio signal transceivers 704 (e.g., Peanut, Bluetooth, Zigbee, WiFi, RF radio) and antennas 708 for sending and receiving wireless signals as described herein. The transceivers 704 and antennas 708 may be used with the above-mentioned circuitry to implement the various wireless transmission protocol stacks and interfaces. The flat screen television 700 may include a cellular network wireless modem chip 720 that enables communication via a cellular network. The flat screen television 700 may also include a physical button 706 for receiving user inputs. The flat screen television 700 may also include various sensors coupled to the processor 701, such as a camera 722, and a microphone or microphones 723.

For example, the flat screen television 700 may have a conventional microphone 723 for receiving voice commands or measuring ambient sound levels. The microphone 723 may be a piezo-electric transducer, or other conventional microphone elements.

The various embodiments may also be implemented on any of a variety of commercially available server mobile devices, such as the server 800 illustrated in FIG. 8. The server 800 may typically include a processor 801 coupled to volatile memory 802 and a large capacity nonvolatile memory, such as a disk drive 803. The server 800 may also include a floppy disc drive, compact disc (CD) or DVD disc drive 804 coupled to the processor 801. The server 800 may also include network access ports 806 coupled to the processor 801 for establishing network interface connections with a network 807, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

The processors 602, 701, and 801 may be any programmable microprocessor, microcomputer or multiple processor chip or chips that can be configured by software instructions (applications) to perform a variety of functions, including the functions of the various embodiments described above. In some mobile devices, multiple processors may be provided, such as one processor dedicated to wireless communication functions and one processor dedicated to running other applications. Typically, software applications may be stored in the internal memory 606, 702, and 802, before being accessed and loaded into the processors 602, 701, and 801. The processors 602, 701, and 801 may include internal memory sufficient to store the application software instructions. In many mobile devices the internal memory may be a volatile or nonvolatile memory, such as flash memory, or a mixture of both. For the purposes of this description, a general reference to memory refers to memory accessible by the processors 602, 701, and 901 including internal memory or removable memory plugged into the mobile device and memory within the processor 602, 701, and 801 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic mobile device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of receiver smart objects, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of adjusting an advertising rate charged to an advertiser for ad content presented by an advertising device, the method comprising:
detecting, by the advertising device, a presence of a mobile device in proximity to the advertising device;
obtaining, by the advertising device, information from the mobile device indicative of a state of attentiveness of a user of the mobile device to the advertising device; and
adjusting, by the advertising device, the advertising rate charged to the advertiser for the ad content presented by the advertising device based on the obtained information indicative of the state of attentiveness of the user of the mobile device.

2. The method of claim 1, wherein the obtained information indicative of the state of attentiveness of the user of the mobile device comprises information associated with one or more of: a distance of the mobile device from the advertising device; a position of the mobile device relative to a field of view of a display of the advertising device; a position of the mobile device relative to a field of audibility of an audio output of the advertising device; an ambient noise level of an area around the advertising device; a placement of the mobile device in a pocket of the user; a state of interactions of the user with the mobile device; a movement of the mobile device; a compass reading of the mobile device; a voice call state of the mobile device; a video call state of the mobile device; a headphone use state of the mobile device; a battery level of the mobile device; and a network signal coverage level of the mobile device.

3. The method of claim 1, wherein adjusting, by advertising device, the advertising rate charged to the advertiser for the ad content presented by the advertising device based on the obtained information indicative of the state of attentiveness of the user of the mobile device comprises increasing, by the advertising device, the advertising rate when the obtained information indicative of the state of attentiveness indicates that the user is likely to be attentive to the ad content.

4. The method of claim 1, wherein adjusting, by the advertising device, the advertising rate charged to the advertiser for the ad content presented by the advertising device based on the obtained information indicative of the state of attentiveness of the user of the mobile device comprises reducing, by the advertising device, the advertising rate when the obtained information indicative of the state of attentiveness indicates that the user is unlikely to be attentive to the ad content.

5. The method of claim 1, wherein detecting, by the advertising device, a presence of a mobile device in proximity to the advertising device comprises assigning, by advertising device, a target grade for the mobile device based on one or more of: a make of the mobile device; a model of the mobile device; applications installed on the mobile device, or a language of the mobile device.

6. The method of claim 5, further comprising adjusting, by the advertising device, the ad content based on the assigned target grade of the mobile device.

7. The method of claim 5, wherein adjusting, by the advertising device, the advertising rate charged to the advertiser for the ad content presented by the advertising device based on the obtained information indicative of the state of attentiveness of the user of the mobile device comprises adjusting, by the advertising device, one or more of: the advertising rate and the ad content, based on one or more of the obtained information and the assigned target grade of the mobile device.

8. The method of claim 1, further comprising:
assigning, by the advertising device, a target grade for each of a plurality of mobile devices in proximity to the advertising device based on one or more of: a make of each mobile device; a model of each mobile device; applications installed on each mobile device, and a language of each mobile device;
calculating, by the advertising device, an aggregate target grade for all of the plurality of mobile devices; and
adjusting, by the advertising device, one or more of the advertising rate and the ad content, based on the aggregate target grade.

9. An advertising device configured to present ad content, comprising:
a memory; and
a processor coupled to the memory and configured with processor-executable instructions to perform operations comprising:
detecting a presence of a mobile device in proximity to the advertising device;
obtaining information from the mobile device indicative of a state of attentiveness of a user of the mobile device to the advertising device; and
adjusting an advertising rate charged to the advertiser for the ad content presented by the advertising device based on the obtained information indicative of the state of attentiveness of the user of the mobile device.

10. The advertising device of claim 9, wherein the obtained information indicative of the state of attentiveness of the user of the mobile device comprises information associated with one or more of: a distance of the mobile device from the advertising device; a position of the mobile device relative to a field of view of a display of the advertising device; a position of the mobile device relative to a field of audibility of an audio output of the advertising device; an ambient noise level of an area around the advertising device; a placement of the mobile device in a pocket of the user; a state of interactions of the user with the mobile device; a movement of the mobile device; a compass reading of the mobile device; a voice call state of the mobile device; a video call state of the mobile device; a headphone use state of the mobile device; a battery level of the mobile device; and a network signal coverage level of the mobile device.

11. The advertising device of claim 9, wherein the processor is configured with processor-executable instructions to perform operations such that adjusting the advertising rate charged to the advertiser for the ad content presented by the advertising device based on the obtained information indicative of the state of attentiveness of the user of the mobile device comprises increasing the advertising rate when the information indicative of the state of attentiveness indicates that the user is likely to be attentive to the ad content.

12. The advertising device of claim 9, wherein the processor is configured with processor-executable instructions to perform operations such that adjusting the advertising rate charged to the advertiser for the ad content presented by the advertising device based on the obtained information indicative of the state of attentiveness of the user of the mobile device comprises reducing the advertising rate when the information indicative of the state of attentiveness indicates that the user is unlikely to be attentive to the ad content.

13. The advertising device of claim 9, wherein the processor is configured with processor-executable instructions to perform operations such that detecting a presence of a mobile device in proximity to the advertising device comprises assigning a target grade for the mobile device based on one or more of: a make of the mobile device; a model of the mobile device; applications installed on the mobile device, or a language of the mobile device.

14. The advertising device of claim 13, wherein the processor is configured with processor-executable instructions to perform operations further comprising adjusting the ad content based on the assigned target grade of the mobile device.

15. The advertising device of claim 13, wherein the processor is configured with processor-executable instructions to perform operations such that adjusting the advertising rate charged to the advertiser for the ad content presented by the advertising device based on the obtained information indicative of the state of attentiveness of the user of the mobile device comprises adjusting one or more of: the advertising rate and the ad content, based on one or more of the obtained information and the assigned target grade of the mobile device.

16. The advertising device of claim 9, wherein the processor is configured with processor-executable instructions to perform operations such that detecting a presence of a mobile device in proximity to the advertising device comprises:
detecting a presence and a location of a plurality of mobile devices in proximity to the advertising device;
assigning a target grade for each of the plurality of mobile devices based on one or more of: a make of each mobile device; a model of each mobile device; applications installed on each mobile device, and a language of each mobile device;
calculating an aggregate target grade for all of the plurality of mobile devices; and
adjusting one or more of: the advertising rate and the ad content, based on the aggregate target grade.

17. A method for adjusting an advertising rate charged to an advertiser for ad content presented by an advertising device, comprising:
receiving, by a server, mobile device characteristics from of a plurality of mobile devices in proximity to the advertising device;
determining, by the server, a state of attentiveness of users of the plurality of mobile devices to the advertising device based on the received mobile device characteristics; and
adjusting, by the server, the advertising rate charged to the advertiser for the ad content presented by the advertising device based on the determined state of attentiveness of the users of the plurality of mobile devices.

18. The method of claim 17, wherein the mobile device characteristics for each mobile device of the plurality of mobile devices comprise information associated with one or more of: a mobile device ID of the mobile device, a mobile device type of the mobile device, a distance of the mobile device from the advertising device; a position of the mobile device relative to a field of view of a display of the advertising device; a position of the mobile device relative to a field of audibility of an audio output of the advertising device; a placement of the mobile device in a pocket of the user; a state of interactions of the user with the mobile device; a movement of the mobile device; a compass reading of the mobile device; a voice call state of the mobile device; a video call state of the mobile device; a headphone use state of the mobile device; a battery level of the mobile device; and a network signal coverage level of the mobile device.

19. The method of claim 17, wherein adjusting, by the server, the advertising rate charged to the advertiser for the ad content presented by the advertising device based on the determined state of attentiveness of the users of the plurality of mobile devices comprises increasing, by the server, the advertising rate when the determined state of attentiveness indicates that the users are likely to be attentive to the ad content.

20. The method of claim 17, wherein adjusting, by the server, the advertising rate charged to the advertiser for the ad content presented by the advertising device based on the determined state of attentiveness of the users of the plurality of mobile devices comprises reducing, by the server, the advertising rate when the determined state of attentiveness indicates that the users are unlikely to be attentive to the ad content.

21. The method of claim 17, further comprising assigning, by the server, a target grade for each mobile device of the plurality of mobile devices based on one or more of the mobile device type of the mobile device, applications installed on the mobile device, or a language of the mobile device.

22. The method of claim 21, further comprising adjusting, by the server, the ad content based on the assigned target grade of the mobile device.

23. The method of claim 21, wherein adjusting, by the server, the advertising rate charged to the advertiser for the ad content presented by the advertising device based on the determined state of attentiveness of the users of the plurality of mobile device comprises adjusting, by the server, one or more of: the advertising rate and the ad content, based on one or more of the mobile device characteristics and the assigned target grade of the plurality of mobile devices.

24. A server, comprising:
a communication framework interface; and
a processor coupled to the communication framework interface, the processor configured with processor-executable instructions configured to perform operations comprising:
receiving mobile device characteristics from a plurality of mobile devices in proximity to the advertising device;
determining a state of attentiveness of users of the plurality of mobile devices to the advertising device based on the received mobile device characteristics; and
adjusting an advertising rate charged to the advertiser for the ad content presented by the advertising device based on the determined state of attentiveness of the users of the plurality of mobile devices.

25. The server of claim 24, wherein the mobile device characteristics for each mobile device of the plurality of mobile devices comprise information associated with one or more of: a mobile device ID of the mobile device, a mobile device type of the mobile device, a distance of the mobile device from the advertising device; a position of the mobile device relative to a field of view of a display of the advertising device; a position of the mobile device relative to a field of audibility of an audio output of the advertising device; a placement of the mobile device in a pocket of the user; a state of interactions of the user with the mobile device; a movement of the mobile device; a compass reading of the mobile device; a voice call state of the mobile device; a video call state of the mobile device; a headphone use state of the mobile device; a battery level of the mobile device; and a network signal coverage level of the mobile device.

26. The server of claim 24, wherein the processor is configured with processor-executable instructions to perform operations further comprising such that adjusting the advertising rate charged to the advertiser for the ad content presented by the advertising device based on the determined state of attentiveness of the users of the plurality of mobile devices comprises increasing the advertising rate when the determined state of attentiveness indicates that the users are likely to be attentive to the ad content.

27. The server of claim 24, wherein the processor is configured with processor-executable instructions to perform operations further comprising such that adjusting the advertising rate charged to the advertiser for the ad content presented by the advertising device based on the determined state of attentiveness of the users of the plurality of mobile devices comprises reducing the advertising rate when the determined state of attentiveness indicates that the users are unlikely to be attentive to the ad content.

28. The server of claim 24, wherein the processor is configured with processor-executable instructions to perform operations further comprising further comprising assigning a target grade for each mobile device of the plurality of mobile devices based on one or more of the mobile device type of the mobile device, applications installed on the mobile device, or a language of the mobile device.

29. The server of claim 28, wherein the processor is configured with processor-executable instructions to perform operations further comprising further comprising adjusting the ad content based on the assigned target grade of the mobile device.

30. The server of claim 28, wherein the processor is configured with processor-executable instructions to perform operations further comprising such that adjusting the advertising rate charged to the advertiser for the ad content presented by the advertising device based on the determined state of attentiveness of the users of the plurality of mobile device comprises adjusting one or more of: the advertising rate and the ad content, based on one or more of the mobile device characteristics and the assigned target grade of the plurality of mobile devices.
